(19) United States
(12) Patent Application Publication
(10) Pub. No.: US 2004/0193916 A1
(43) Pub. Date: Sep. 30, 2004

(54) Central processing unit and computer program

(75) Inventors: Jun Kamada, Kawasaki (JP); Seigo Kotani, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/822,689

(22) Filed: Apr. 13, 2004

Related U.S. Application Data
(63) Continuation-in-part of application No. PCT/JP01/10446, filed on Nov. 29, 2001.

(51) Int. Cl. H04L 9/00

(52) U.S. Cl. 713/200; 713/176

(57) ABSTRACT

A central processing unit includes an operation mode storing unit that stores at least one first operation mode from among a plurality of second operation modes, a usable command storing unit that stores at least one command corresponding to each of the at least one first operation mode stored as at least one usable command, an operation mode adding/setting unit that adds into the operation mode storing unit a dynamically specified operation mode from the second operation modes, and sets in the usable command storing unit a command corresponding to the operation mode added, and a firmware acquiring unit that acquires from the outside, firmware that corresponds to the at least one first operation mode stored and that is used for executing the at least one usable command.

### CROSS-REFERENCE TO RELATED APPLICATIONS

This application is a continuation-in-part of international application no. PCT/JP01/10446, with an international filing date of Nov. 29, 2001, designating the United States. Priority of the above-mentioned application is claimed and the above-mentioned application is hereby incorporated by reference in its entirety.

### BACKGROUND OF THE INVENTION

1) Field of the Invention

The present invention relates to a central processing unit and a computer program that makes it possible to maintain information security and improve extensibility.

2) Description of the Related Art

In recent years, with the spread of E-commerce on the Internet there has been an increase in the demand for more advanced security of information. Therefore, computers used for the E-commerce require security functions such as authentication, encryption/decryption, and creating/verifying of digital signature. Ideally, it is desirable that the security functions are realized by a security system composed of a plurality of computers having independent security functions.

FIG. 46 is a block diagram of a conventional security system. A computer 10 is connected to the Internet 20 and an intranet 30, and an authentication CPU (central processing unit) 11 authenticates information. The authentication CPU 11 uses a command group specific to the authentication process, to increase information security.

A computer 40 is connected to the intranet 30, and an encryption/decryption CPU 41 realizes an encryption/decryption function. The encryption/decryption CPU 41 uses a command group specific to the encryption/decryption process.

A computer 50 is connected to the intranet 30, and a digital signature creating/verifying CPU 51 creates/verifies digital signature. The digital signature creating/verifying CPU 51 uses a command group specific to the creating/verifying of digital signature.

A computer 60 is connected to the intranet 30, and a general CPU 61 realizes a general function other than the security functions. The general CPU 61 uses a group of general-purpose commands. In the conventional security system, these computers realize the respective security functions.

However, in the conventional security system mentioned above, the command groups used by the respective computers to strengthen security of information are predefined. Therefore, the conventional security system is less extensible.

With new security techniques being developed rapidly, old computers need to be replaced by computers in which command groups can be updated every time a new technique is developed. Consequently, the cost increases.

### SUMMARY OF THE INVENTION

It is an object of the present invention to solve at least the problems in the conventional technology.

To achieve the objectives mentioned above, the present invention provides a central processing unit, which includes an operation mode storing unit that stores at least one first operation mode from among a plurality of second operation modes, a usable command storing unit that stores at least one command corresponding to the at least one first operation mode stored as at least one usable command, an operation mode adding/setting unit that adds into the operation mode storing unit a dynamically specified operation mode from the second operation modes, and sets in the usable command storing unit a command corresponding to the operation mode added, and a firmware acquiring unit that acquires from outside, firmware that corresponds to the at least one first operation mode stored and that is used for executing the at least one usable command.

Moreover, the present invention includes a computer program that makes a computer execute the functions of storing at least one first operation mode from among a plurality of second operation modes, storing at least one command corresponding to the at least one first operation mode stored as at least one usable command, adding a dynamically specified operation mode from the second operation modes, and setting a command corresponding to the operation mode added, and acquiring from outside, firmware that corresponds to the at least one first operation mode stored and that is used for executing the at least one usable command.

According to the present invention, a dynamically specified operation mode is added into an operation mode retaining unit, and a command corresponding to the operation mode added is set in a usable command retaining unit. Further, firmware to be used for executing the command is acquired from the outside. Therefore, while security of information is maintained, extensibility improves, and cost reduces.

Furthermore, the present invention provides a central processing unit, which includes an operation mode storing unit that stores at least one first operation mode from among a plurality of second operation modes, a usable command storing unit that stores at least one command corresponding to the at least one first operation mode stored as at least one usable command, an operation mode adding/setting unit that adds into the operation mode storing unit a dynamically specified operation mode from the second operation modes, and sets in the usable command storing unit a command corresponding to the operation mode added, and a logic circuit data acquiring unit that acquires logic circuit data from the outside for generating a logic circuit that corresponds to the at least one first operation mode stored and that is used for executing the at least one usable command.

According to the present invention, a dynamically specified operation mode is added into the operation mode storing unit, and a command corresponding to the operation mode added is set in the usable command storing unit. Further, logic circuit data that corresponds to an operation mode stored in the operation mode storing unit and that is used for generating a logic circuit to be used for executing the command, are acquired from the outside. Therefore, while security of information is maintained, extensibility improves, and cost reduces.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a constitution according to a first embodiment of the present invention;

FIG. 2 is a block diagram of a CPU shown in FIG. 1;

FIG. 3 illustrates an operation mode/command table;

FIG. 4 is a flowchart of an operation of the CPU shown in FIG. 2, an operation of a CPU shown in FIG. 27, an operation of a CPU shown in FIG. 34 and an operation of a CPU shown in FIG. 43;

FIG. 5 is a flowchart of a normal command executing process shown in FIGS. 4, 18 and 23;

FIG. 6 is a flowchart of an operation mode adding process shown in FIGS. 4, 18 and 23;

FIG. 7 is a flowchart of a firmware download process shown in FIG. 4;

FIG. 8 is a flowchart of an operation of the first embodiment;

FIG. 9 is a block diagram of a constitution according to a second embodiment;

FIG. 10 is a block diagram of a CPU shown in FIG. 9;

FIG. 11 is a flowchart of an operation of the CPU shown in FIG. 10;

FIG. 12 is a flowchart of a normal command executing process shown in FIG. 11;

FIG. 13 is a flowchart of an operation mode adding process shown in FIG. 11;

FIG. 14 is a flowchart of a logic circuit data download process;

FIG. 15 is a flowchart of an operation of the second embodiment;

FIG. 16 is a block diagram of a constitution according to a third embodiment;

FIG. 17 is a block diagram of a CPU shown in FIG. 16;

FIG. 18 is a flowchart of an operation of the CPU shown in FIG. 17;

FIG. 19 is a flowchart of an encrypted firmware download process;

FIG. 20 is a flowchart of an operation of the third embodiment;

FIG. 21 is a block diagram of a constitution according to a fourth embodiment;

FIG. 22 is a block diagram of a CPU shown in FIG. 21;

FIG. 23 is a flowchart of an operation of the CPU shown in FIG. 21;

FIG. 24 is a flowchart of a firmware with digital signature download process;

FIG. 25 is a flowchart of an operation of the fourth embodiment;

FIG. 26 is a block diagram of a constitution according to a fifth embodiment;

FIG. 27 is a block diagram of a CPU shown in FIG. 26;

FIG. 28 illustrates an operation mode/resource table;

FIG. 29 is a flowchart of a normal command executing process;

FIG. 30 is a flowchart of an access control process shown in FIG. 29;

FIG. 31 is a flowchart of an operation mode adding process;

FIG. 32 is a block diagram of a constitution according to a sixth embodiment;

FIG. 33 illustrates a data structure of operation mode files;

FIG. 34 is a block diagram of an operating system and a CPU shown in FIG. 32;

FIG. 35 is a flowchart of an operation of the operating system shown in FIG. 34;

FIG. 36 is a block diagram of a constitution according to a seventh embodiment;

FIG. 37 is a block diagram of a CPU and an operating system shown in FIG. 36;

FIG. 38 is a flowchart of an operation of the CPU shown in FIG. 37;

FIG. 39 is a flowchart of an operation mode deleting process;

FIG. 40 is a flowchart of a firmware unload process;

FIG. 41 is a flowchart of an operation of the operating system shown in FIG. 37;

FIG. 42 is a block diagram of a constitution according to an eighth embodiment;

FIG. 43 is a block diagram of a CPU and an emulating section shown in FIG. 42;

FIG. 44 is a flowchart of an operation of the emulating section;

FIG. 45 is a block diagram of a modified example of the embodiments of the present invention; and

FIG. 46 is a block diagram of a conventional security system.

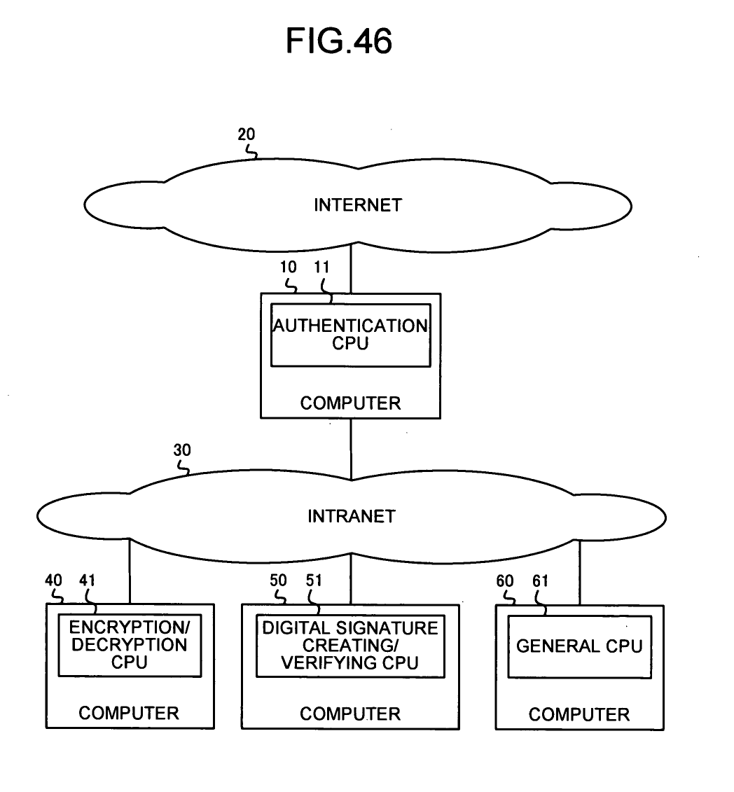

### DETAILED DESCRIPTION

Exemplary embodiments of a central processing unit and a computer program (operation program) according to the present invention will be explained in detail with reference to the accompanying drawings.

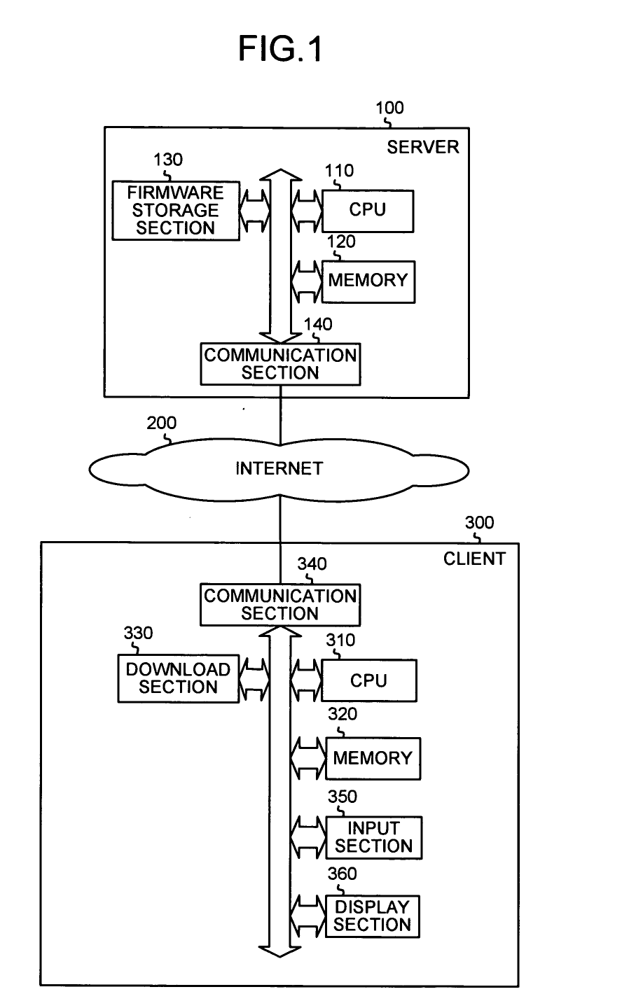

FIG. 1 is a block diagram of a system according to a first embodiment of the present invention. A server 100 provides firmware to a client 300 via the Internet 200. A CPU 110 in the server 100 controls the providing of the firmware.

A memory 120 stores control data, and may be a RAM (Random Access Memory), a ROM (Read Only Memory), or the like. A firmware storage section 130 stores firmware to be used for executing a command in the CPU 310 of the client (described later). The firmware corresponds to firmware numbers.

A communication section 140 controls communication in the server 100 using communication protocols such as TCP/IP (Transmission Control Protocol/Internet Protocol).

The client 300 is connected to the Internet 200, and includes a function for downloading firmware from the server 100 via the Internet 200, and a function for executing various commands using the firmware to output results.

In the client 300, a CPU 310 controls dynamic download of firmware and sets an operation mode and a command group (described later). A memory 320 stores control data of the CPU 310, and is composed of a RAM, a ROM, or the like. A download section 330 downloads firmware from the server 100 based on the control of the CPU 310. An input section 350 is an input device such as a keyboard and a mouse. A display section 360 displays results of commands executed.

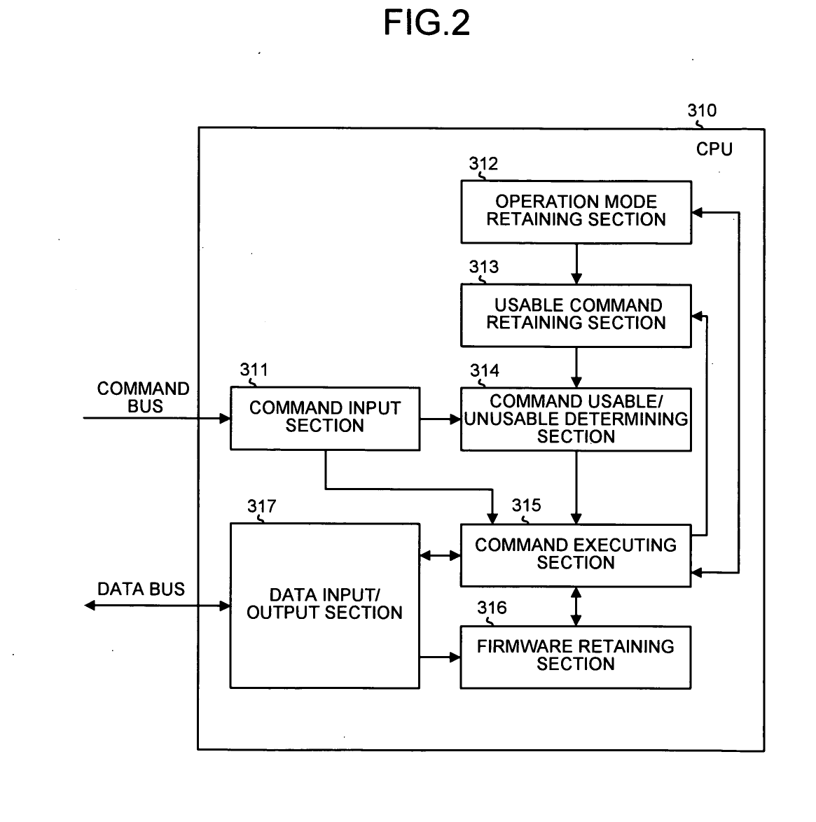

FIG. 2 is a block diagram of the CPU 310 shown in FIG. 1. A command input section 311 inputs a command via a command bus, and fetches the command to a command executing section 315 and a command usable/unusable determining section 314. An operation mode retaining section 312 retains operation modes of the CPU 310.

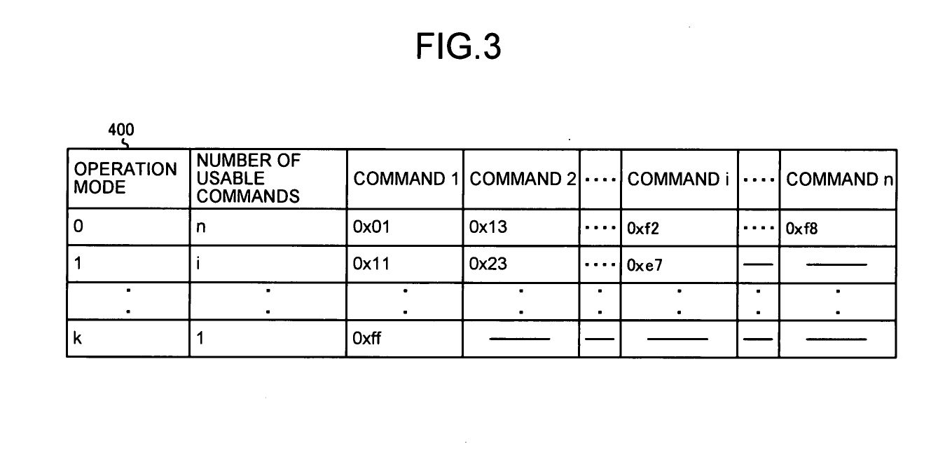

FIG. 3 illustrates an operation mode/command table 400 that stores the operation modes and the commands corresponding to the operation modes. In the operation mode/command table 400, the operations modes are designated by “0” to “k”. The number of usable commands is set for each operation mode, and this number represents the number of the commands that can be used in the corresponding operation mode in the command executing section 315.

For example, the number of usable commands for the operation mode 0 is n. That is, for the operation mode 0, n types of commands including a command 1 (0x01) to a command n (0xf8) are usable in the command executing section 315.

The number of usable commands for the operation mode 1 is i. That is, for the operation mode 1, i types of commands including a command 1 (0x11) to a command i (0xe7) are usable in the command executing section 315. Further, when the operation mode 1 is set, commands other than the command 1 (0x11) to the command i (0xe7) cannot be used in the command executing section 315.

Similarly, for the operation mode k, the number of usable commands is 1. That is, for the operation mode k, one type of a command 1 (0xff) is usable in the command executing section 315. When the operation mode k is set, commands other than the command 1 (0xff) cannot be used in the command executing section 315. The operation modes sets in the operation mode retaining section 312 can be added dynamically.

With reference to FIG. 2, a usable command retaining section 313 retains usable commands corresponding the operation modes set in the operation mode retaining section 312.

For example, when the operation mode 0 shown in FIG. 3 is set in the operation mode retaining section 312, the command 1 (0x01) to a command n (0xf8) that correspond to the operation mode 0 are retained as the usable commands in the usable command retaining section 313.

The command usable/unusable determining section 314 determines whether the command fetched by the command input section 311 is usable. Concretely, the command usable/unusable determining section 314 refers to the operation mode/command table 400, and if the command fetched is included in the group of usable commands corresponding to the current operation mode set in the operation mode retaining section 312, command usable/unusable determining section 314 determines the command as usable.

On the other hand, when the command fetched is not included in the command group, the command usable/unusable determining section 314 determines the command as unusable. In the first embodiment, the usable commands corresponding to the operation modes are limited.

The command executing section 315 executes the command determined as usable by the command usable/unusable determining section 314. Further, the command executing section 315 acquires firmware to be used for executing the command, from a firmware retaining section 316.

The firmware retaining section 316 retains firmware corresponding to the command group in the operation mode set in the operation mode retaining section 312. The firmware is downloaded from the server 100. When a new command is added by addition of an operation mode, the firmware retaining section 316 retains new firmware.

A data input/output section 317 inputs various data necessary for executing the command in the command executing section 315 and outputs results.

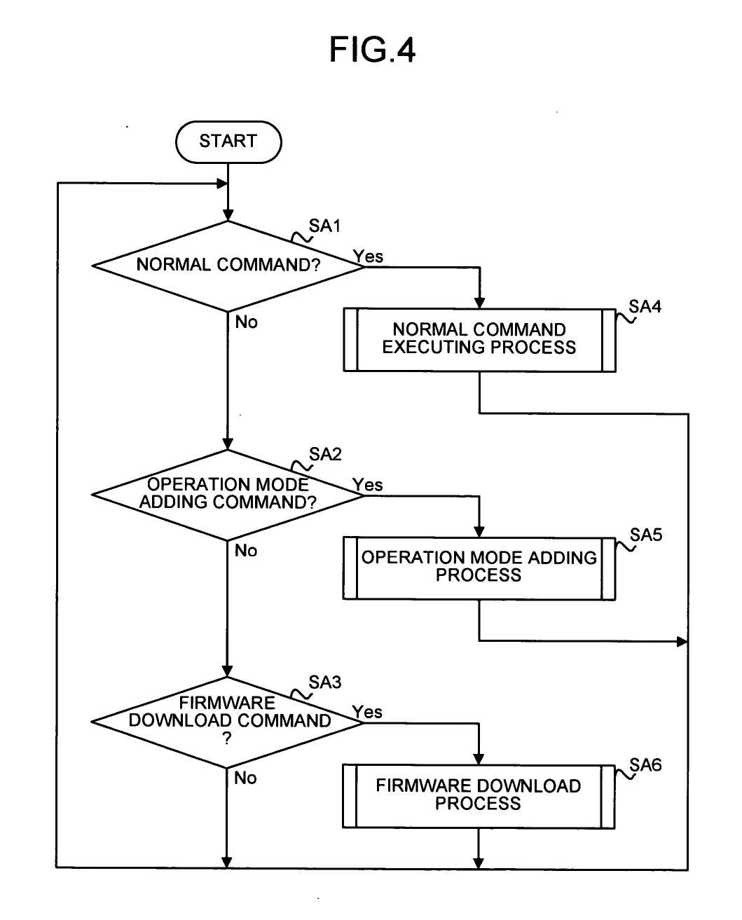

An operation of the CPU 310 according to the first embodiment is explained below with reference to flowcharts shown in FIGS. 4 to 8. The CPU 310 determines whether a normal command is input (step SAl shown in FIG. 4), and in this case the result is assumed to be “No”. The normal command is a command other than an operation mode adding command and a firmware download command, (described later) and is executed by the CPU 310.

The CPU 310 determines whether an operation mode adding command is input (step SA2), and in this case the result is assumed to be “No”. The operation mode adding command is for adding an operation mode into the operation mode/command table 400.

The CPU 310 determines whether a firmware download command is input (step SA3). In this case, the result is assumed to be “No”, and the control goes to step SA1. The firmware download command is for setting firmware acquired from the server 100 via the Internet 200 in the CPU 310. Thereafter, the CPU 310 repeats the steps SA1 to SA3.

If the normal command is input, the CPU 310 sets the result at step SA1 to “Yes”. The CPU 310 executes a normal command executing process at step SA4.

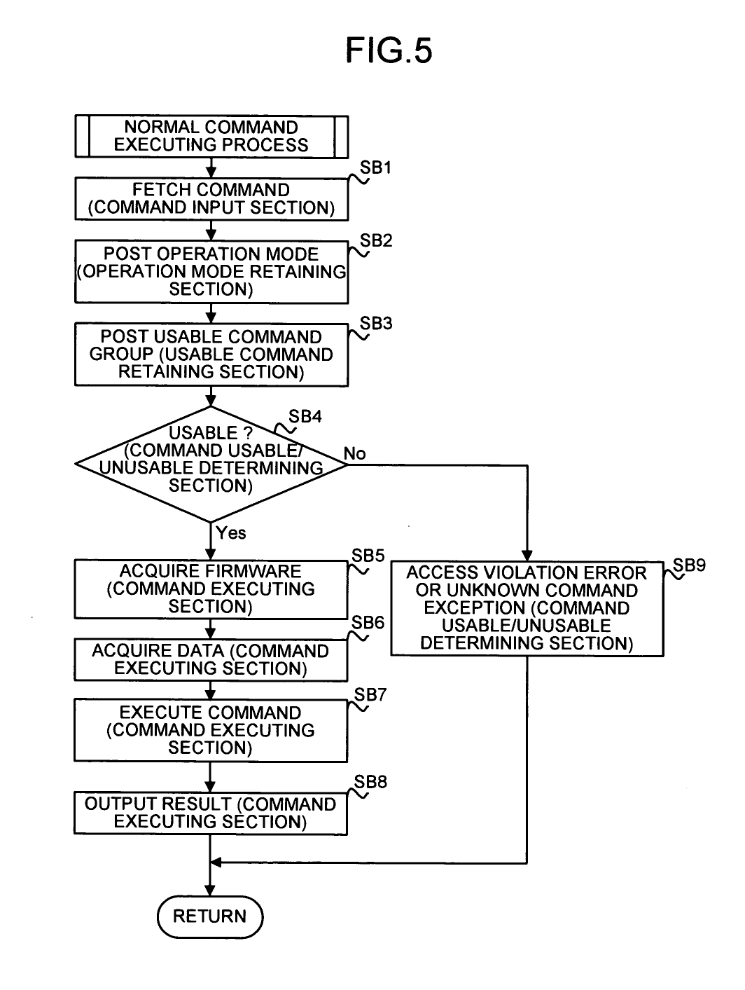

FIG. 5 is a flowchart of the normal command executing process. The command input section 311 (see FIG. 2) fetches the normal command input via the command bus to the command usable/unusable determining section 314 and the command executing section 315 (step SB1). The operation mode retaining section 312 posts the operation mode set at this time to the usable command retaining section 313 (step SB2). The operation mode posted is assumed to be “1” as shown in FIG. 3.

The usable command retaining section 313 posts a command group corresponding to the operation mode posted, as the usable command group, to the command usable/unusable determining section 314 (step SB3). The usable command group in this case includes the command 1 (0x11) to the command i (0xe7) corresponding to the operation mode 1 as shown in FIG. 3.

The command usable/unusable determining section 314 determines whether the normal command fetched at step SB1 is usable in the operation mode (step SB4). Concretely, the command usable/unusable determining section 314 determines whether the usable command group posted at step SB3 includes the normal command fetched at step SB1, and in this case, the result is assumed to be “Yes”.

The command executing section 315 acquires firmware corresponding to the normal command fetched at step SB1 from the firmware retaining section 316 (step SB5). The command executing section 315 acquires data to be used for executing the command from the data input/output section 317 (step SB6). The command executing section 315 executes the normal command using the firmware and the data (step SB7). The command executing section 315 outputs a result of execution via the data input/output section 317 (step SB8).

On the other hand, if the result at step SB4 is “No”, namely, the normal command fetched at step SB1 is unusable in the operation mode 1, the command usable/unusable determining section 314 processes the normal command as access violation error or unknown command exception (step SB9).

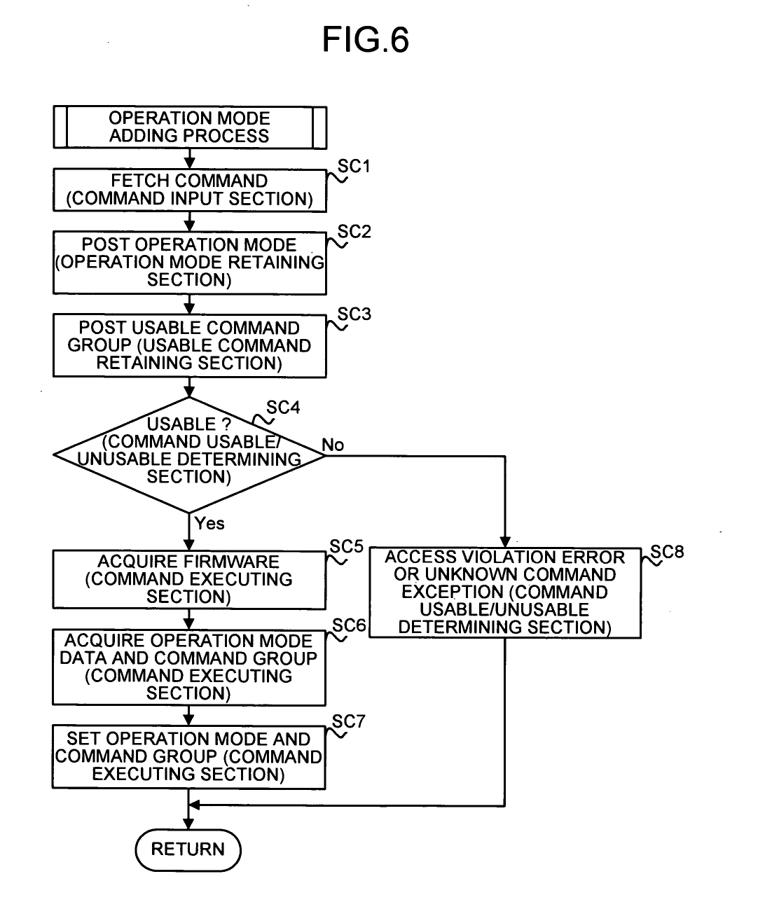

To enable the CPU 310 to execute the command n (0xf8) (operation mode 0) not included in the command group corresponding to the operation mode 1 (see FIG. 3), the operation mode 0 may be added. The operation mode adding process is explained below with reference to the flowchart in FIG. 6.

If the operation mode adding command is input, the CPU 310 sets the result at step SA2 shown in FIG. 4 to “Yes”, and executes the operation mode adding process at step SA5.

Concretely, the command input section 311 (see FIG. 2) fetches the operation mode adding command input via the command bus to the command usable/unusable determining section 314 and the command executing section 315 (step SC1). The operation mode retaining section 312 posts the operation mode set at this time (in this case, the operation mode 1) to the usable command retaining section 313 (step SC2).

The usable command retaining section 313 posts the command 1 (0x11) to the command i (0xe7) corresponding to the operation mode 1 as the usable command group, to the command usable/unusable determining section 314 (step SC3).

The command usable/unusable determining section 314 determines whether the operation mode adding command fetched at step SC1 is usable in the operation mode (step SC4). Concretely, the command usable/unusable determining section 314 determines whether the usable command group posted at step SC3 includes the operation mode adding command fetched at step SC1, and in this case, a result is assumed to be “Yes”.

The command executing section 315 acquires the firmware corresponding to the operation mode adding command (usable command) fetched at step SC1 from the firmware retaining section 316 (step SC5).

The command executing section 315 acquires the operation mode data and the command group from the data input/output section 317 (step SC6). In this case, the operation mode data corresponding to the operation mode to be added are “0”, and the command group includes the command 1 (0x01) to the command n (0xf8) corresponding to the operation mode 0 (see FIG. 3).

The command executing section 315 sets the operation mode 0 to be added, into the operation mode retaining section 312, and sets a command group corresponding to the operation mode 0 in the usable command retaining section 313 (step SC7). Consequently, the command group is usable in the operation mode 0.

On the other hand, if the result at step SC4 is “No”, namely, the operation mode adding command fetched at step SC1 is unusable in the operation mode 1, the command usable/unusable determining section 314 processes this command as access violation error or unknown command exception (step SC8).

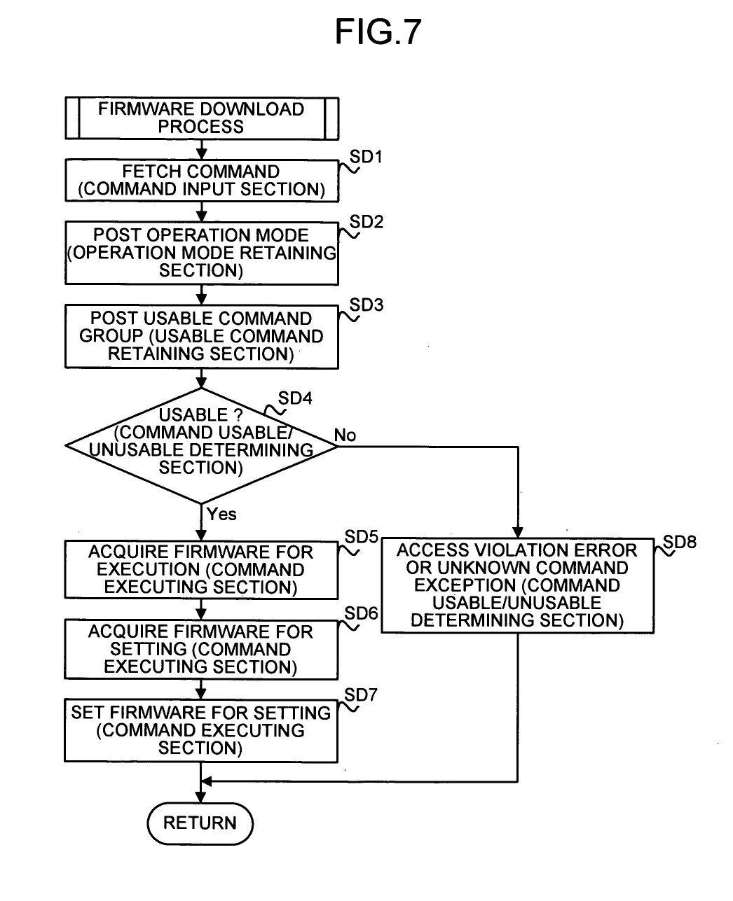

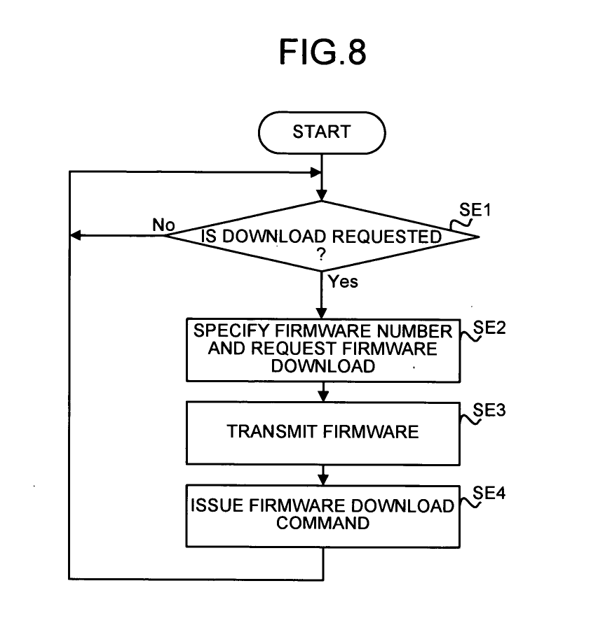

In the command group corresponding to the operation mode 0 added by the operation mode adding process, when the firmware necessary for executing the command is not retained in the firmware retaining section 316, the firmware is downloaded from the server 100. The firmware download process is explained below with reference to the flowcharts in FIGS. 7 and 8.

At step SE1 in FIG. 8, the download section 330 shown in FIG. 1 determines whether the CPU 310 requested for a download. In this case, the result is assumed to be “No”, and the determination is repeated.

When the CPU 310 requests the download section 330 to download the firmware, the download section 330 sets the result at step SE1 to “Yes”. The download section 330 specifies a firmware number corresponding to the firmware requested by the CPU 310 based on a firmware/firmware number table (not shown) (step SE2). The download section 330 posts the firmware download request to the server 100 via the Internet 200, based on the firmware number.

Consequently, the CPU 110 of the server 100 reads the firmware from the firmware storage section 130 using the firmware number as a key, and transmits the firmware to the download section 330 of the client 300 (step SE3).

When the firmware is transmitted, the download section 330 issues the firmware download command to the CPU 310 (step SE4), and control returns to step SE1.

When the firmware download command is input, the CPU 310 sets the result at step SA3 shown in FIG. 4 to “Yes”, and executes the firmware download process at step SA6.

Concretely, at step SD1 shown in FIG. 7, the command input section 311 (see FIG. 2) fetches the firmware download command input via the command bus to the command usable/unusable determining section 314 and the command executing section 315. The operation mode retaining section 312 posts the operation modes set at this time (in this case, the operation modes 0 and 1) to the usable command retaining section 313 (step SD2).

The usable command retaining section 313 posts the command 1 (0x01) to the command n (0xf8), and the command 1 (0x11) to the command i (0xe7) corresponding respectively to the operation modes 0 and 1 posted, as the usable command groups to the command usable/unusable determining section 314 (step SD3).

The command usable/unusable determining section 314 determines whether the firmware download command fetched at step SD1 is usable in the operation modes 0 and 1 (step SD4). Concretely, the command usable/unusable determining section 314 determines whether the usable command groups posted at step SD3 include the firmware download command fetched at step SD1. In this case, a result is assumed to be “Yes”.

The command executing section 315 acquires the firmware for execution corresponding to the firmware download command (usable command) fetched step SD1 from the firmware retaining section 316 (step SD5).

The command executing section 315 acquires the firmware for setting from the download section 330 via the data input/output section 317 and the data bus, based on the firmware download command and the corresponding firmware for execution (step SD6).

The command executing section 315 sets the firmware for setting in the firmware retaining section 316 (step SD7). Consequently, the command group is usable in the operation mode 0 added by the operation mode adding process.

On the other hand, when the result at step SD4 is “No”, namely, the firmware download command fetched at step SD1 is unusable in the operation modes 0 and 1, the command usable/unusable determining section 314 processes this command as access violation error or unknown command exception (step SD8).

Thus, according to the first embodiment, the dynamically specified operation mode from the plurality of operation modes, is added into the operation mode retaining section 312, and the command corresponding to the operation mode added is set in the usable command retaining section 313. Further, the firmware to be used for executing the command is acquired from the external server 100. Therefore, while the security of information is maintained, extensibility improves, and cost reduces.

In the first embodiment, the command executing section 315 executes the command using firmware. However, the command may be executed using a logic circuit instead of firmware. This case is explained below as a second embodiment.

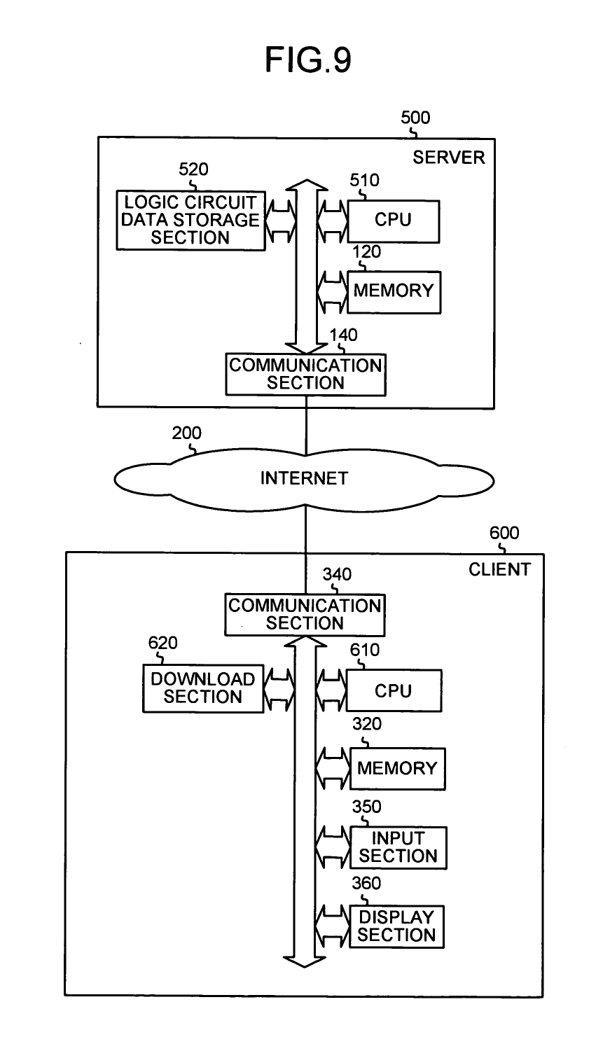

FIG. 9 is a block diagram of a constitution according to the second embodiment of the present invention. Portions corresponding to the portions shown in FIG. 1 are designated by identical reference numbers, and the explanation thereof is omitted. A server 500 provides logic circuit data to a client 600 via the Internet 200.

The logic circuit data are used for generating a logic circuit that realizes the function of the firmware explained in the first embodiment. In the server 500, a CPU 510 controls providing of the logic circuit data.

A logic circuit data storage section 520 stores logic circuit data for generating the logic circuit to be used for executing a command in a CPU 610 of the client (described later). The logic circuit data correspond to logic circuit data numbers.

The client 600 is connected to the Internet 200. The client 600 includes a function for downloading the logic circuit data from the server 500 via the Internet 200, a function for generating the logic circuit based on the logic circuit data, and a function for executing various commands using the logic circuit to output results.

In the client 600, the CPU 610 controls dynamic download of the logic circuit data and sets operation modes and command groups (described later). A download section 620 downloads the logic circuit data from the server 500 based on the control of the CPU 610.

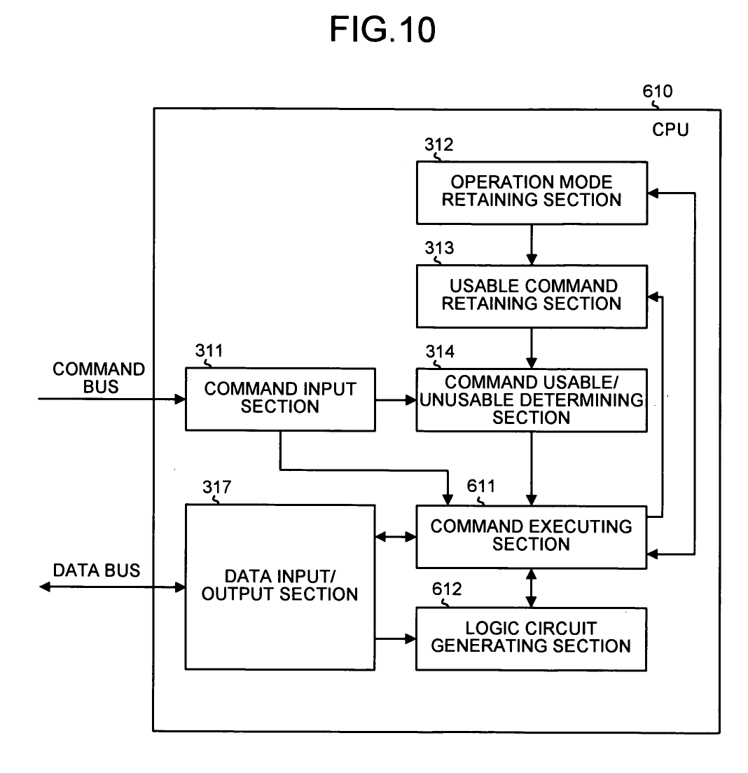

FIG. 10 is a block diagram of the CPU 610 shown in FIG. 9. Portions corresponding to those in FIG. 2 are designated by identical reference numbers, and the explanation thereof is omitted. In the CPU 610, a command executing section 611 includes the logic circuit that is generated dynamically, and executes a command determined as usable by the command usable/unusable determining section 314 in the logic circuit. Moreover, the command executing section 611 makes a logic circuit generating section 612 dynamically generate the logic circuit based on the logic circuit data corresponding to the command. The logic circuit generating section 612 retains the logic circuit data corresponding to the command group in the operation modes set in the operation modes retaining section 312. The logic circuit generating section 612 generates the logic circuit, corresponding to the command to be executed by the command executing section 611 under the control of the command executing section 611, in the command executing section 611.

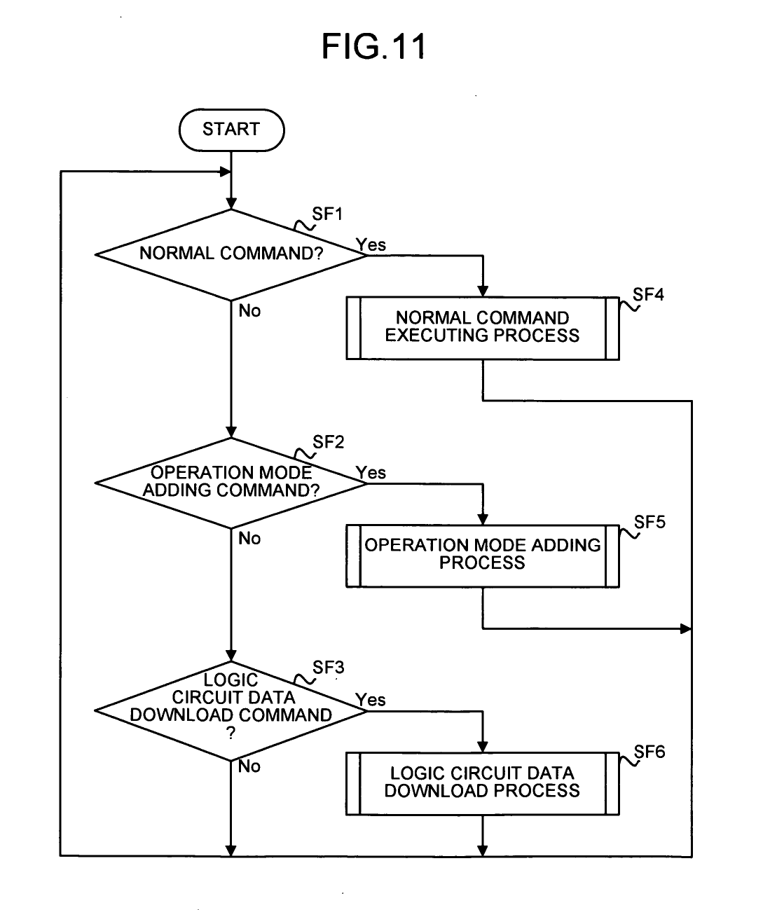

An operation of the second embodiment is explained below with reference to flowcharts shown in FIGS. 11 to 15. The CPU 610 determines whether a normal command is input (step SF1 shown in FIG. 11), and in this case, the result is assumed to be “No”. The normal command is a command other than the operation mode adding command in the first embodiment and the logic circuit data download command,and is executed by the CPU 610.

The CPU 610 determines whether the operation mode adding command is input (step SF2), and in this case, the result is assumed to be “No”. The operation mode adding command is for adding an operation mode in the operation mode/command table 400 shown in FIG. 3.

The CPU 610 determines whether a logic circuit data download command is input (step SF3). In this case, the result. is assumed to be “No”, and the control goes to step SF1. The logic circuit data download command is for downloading the logic circuit data from the server 500 via the Internet 200. Thereafter, the CPU 610 repeats the steps SF1 to SF3.

When the normal command is input, the result at step SF1 is “Yes”. The CPU 610 executes the normal command executing process at step SF4.

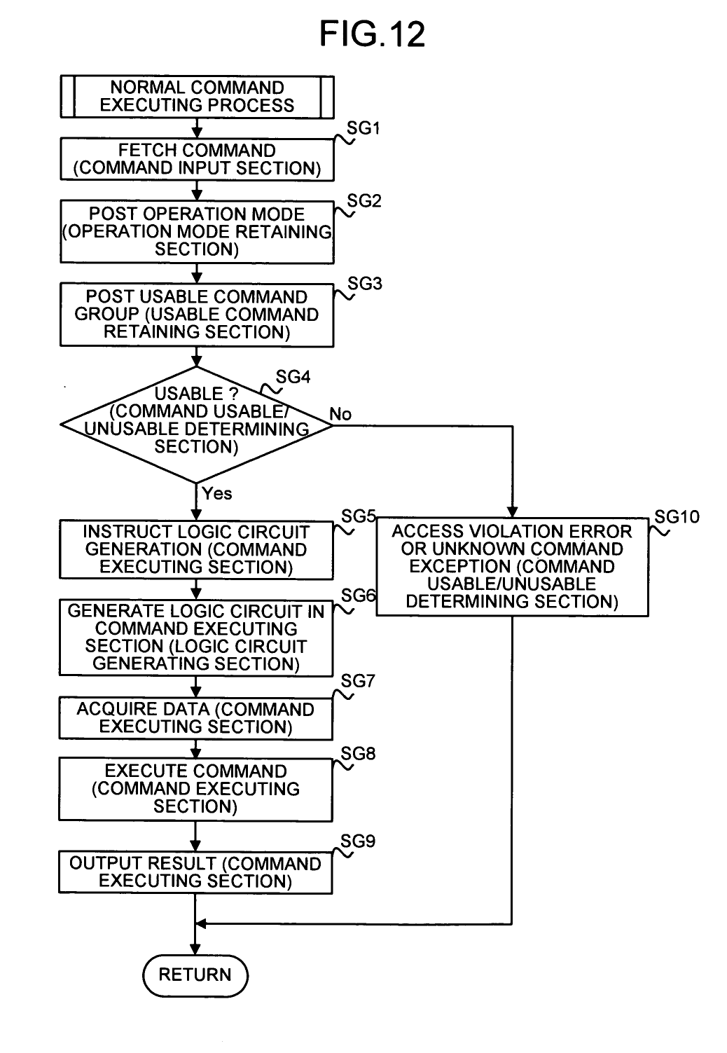

FIG. 12 is a flowchart of a normal command executing process. The command input section 311 (see FIG. 10) fetches the normal command input via the command bus to the command usable/unusable determining section 314 and the command executing section 611 (step SG1). The operation mode retaining section 312 posts the operation mode set at this time to the usable command retaining section 313 (step SG2). The operation mode is assumed to be “1” as shown in FIG. 3.

The usable command retaining section 313 posts the command group corresponding to the operation mode posted as the usable command group, to the command usable/unusable determining section 314 (step SG3). The usable command group in this case includes the command 1 (0x11) to the command i (0xe7) corresponding to the operation mode 1 shown in FIG. 3.

The command usable/unusable determining section 314 determines whether the normal command fetched at step SG1 is usable in the operation mode (step SG4). Concretely, the command usable/unusable determining section 314 determines whether the usable command group posted at step SG3 includes the normal command fetched at step SG1. In this case, the result is assumed to be “Yes”.

At step SG5, the command executing section 611 instructs the logic circuit generating section 612 to generate the logic circuit corresponding to the normal command fetched at step SG1. The logic circuit generating section 612 generates the logic circuit in the command executing section 611 based on the logic circuit data corresponding to the normal command (step SG6).

The command executing section 611 acquires data to be used for executing the command from the data input/output section 317 (step SG7). The command executing section 611 executes the normal command using the logic circuit generated and the data (step SG8). The command executing section 611 outputs a result of execution via the data input/output section 317 (step SG9).

On the other hand, if the result at step SG4 is “No”, namely, the normal command fetched at step SG1 is unusable in the operation mode 1, the command usable/unusable determining section 314 processes the command as access violation error or unknown command exception (step SG10).

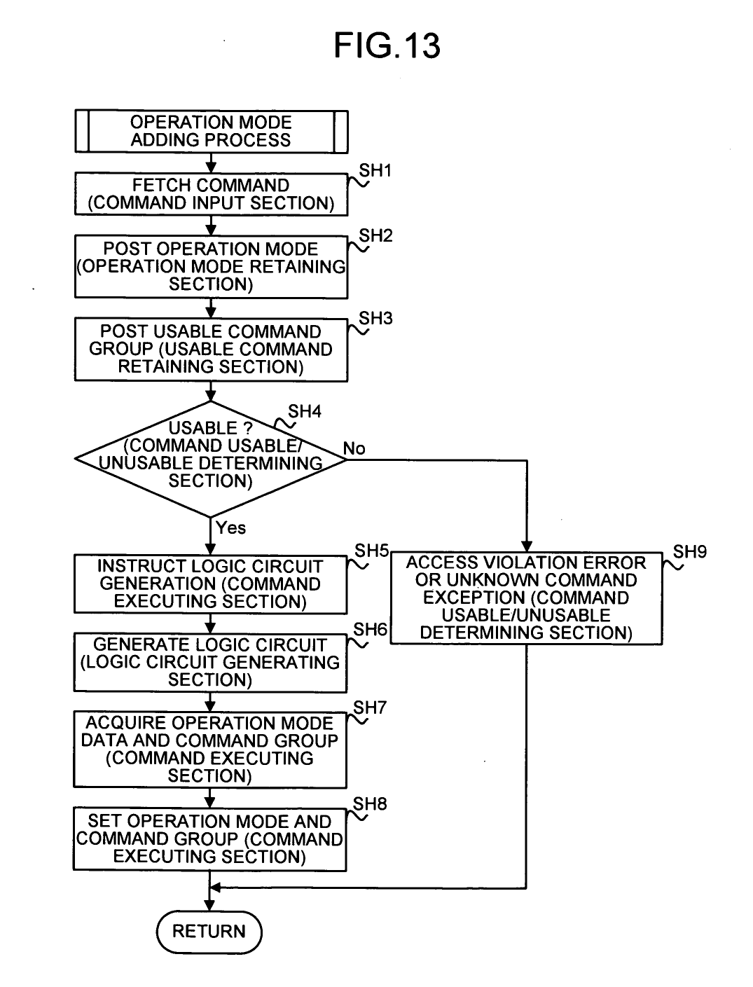

To enable the CPU 610 to execute the command n (0xf8) (operation mode 0) that is not included in the command group corresponding to the operation mode 1, the operation mode 0 may be added. The operation mode adding process is explained below with reference to the flowchart in FIG. 13.

If the operation mode adding command is input, the CPU 610 sets the result at step SF2 shown in FIG. 11 to “Yes”. The CPU 610 executes the operation mode adding process at step SF5.

Concretely, the command input section 311 (see FIG. 10) fetches the operation mode adding command input via the command bus to the command usable/unusable determining section 314 and the command executing section 611 (step SH1). The operation mode retaining section 312 posts the operation mode set at this time (in this case, the operation mode 1) to the usable command retaining section 313 (step SH2).

The usable command retaining section 313 posts the command 1 (0x11) to the command i (0xe7) corresponding to the operation mode 1 as the usable command group to the command usable/unusable determining section 314 (step SH3).

The command usable/unusable determining section 314 determines whether the operation mode adding command fetched at step SH1 is usable in the operation mode (step SH4), similar to step SC4 (see FIG. 6). In this case, the result is assumed to be “Yes”.

At step SH5, the command executing section 611 instructs the logic circuit generating section 612 to generate the logic circuit corresponding to the operation mode adding command (usable command) fetched at step SH1. The logic circuit generating section 612 generates the logic circuit in the command executing section 611 based on the logic circuit data corresponding to the operation mode adding command (step SH6).

The command executing section 611 acquires the operation mode data and the command group from the data input/output section 317 (step SH7). In this case, the operation mode data are “0” corresponding to the operation mode to be added (see FIG. 3). The command group includes the command 1 (0x01) to the command n (0xf8) corresponding to the operation mode 0 shown in FIG. 3.

The command executing section 611 sets the operation mode 0 into the operation mode retaining section 312, and sets the command group corresponding to the operation mode 0 into the usable command retaining section 313 (step SH8). Consequently, the command group is usable in the operation mode 0.

On the other hand, if the determined result at step SH4 is “No”, the command usable/unusable determining section 314 processes the command as access violation error or unknown command exception (step SH9).

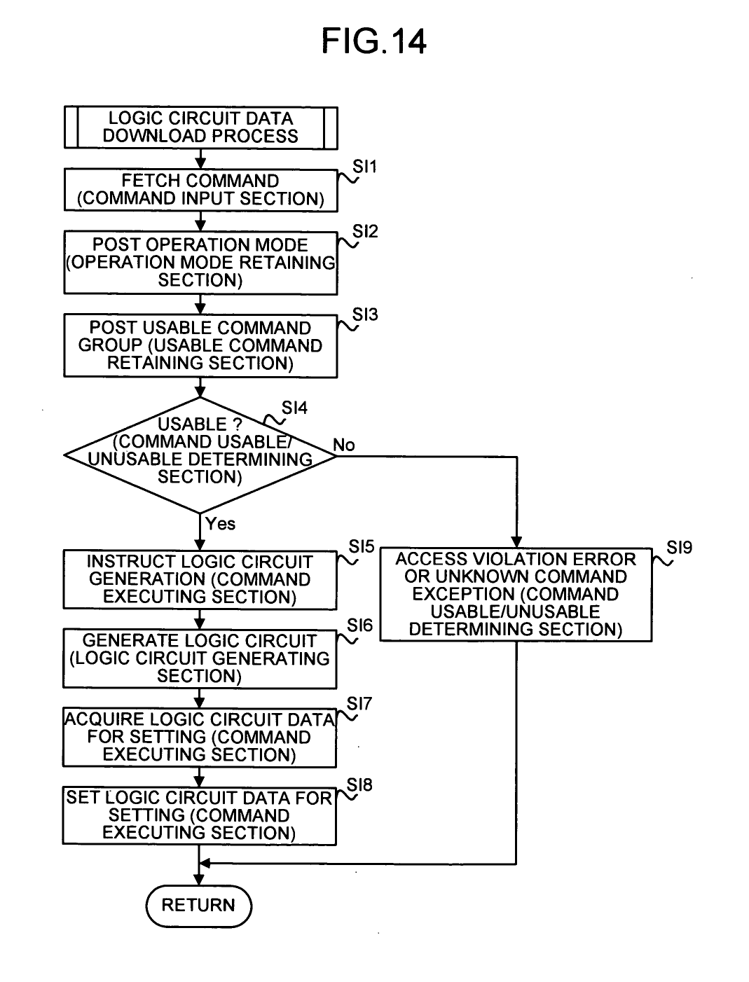

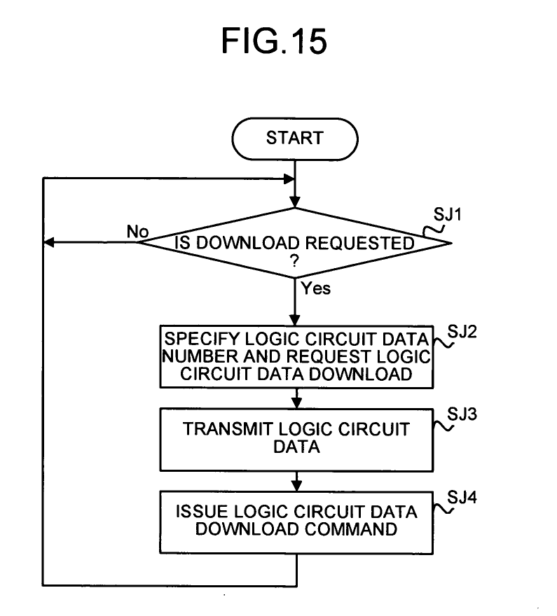

In the command group corresponding to the operation mode 0 added by the operation mode adding process, when the logic circuit data necessary for executing the command are not retained in the logic circuit data retaining section 316, the logic circuit data is downloaded from the server 500. The logic circuit data download process is explained below with reference to the flowcharts in FIG. 14 and 15.

At step SJ1 in FIG. 15, the download section 620 shown in FIG. 9 determines whether the CPU 610 requested for a download. In this case, the result is assumed to be “No”, and the determination is repeated.

When the CPU 610 requests the download section 620 to download the logic circuit data, the download section 620 sets the result at step SJ1 to “Yes”. The download section 620 specifies a logic circuit data number corresponding to the logic circuit data requested by the CPU 610 based on a logic circuit data/logic circuit data number table (not shown) (step SJ2).

The download section 620 posts the logic circuit data download request to the server 500 via the Internet 200, based on the logic circuit data number.

Consequently, the CPU 510 of the server 500 reads the logic circuit data from the logic circuit data storage section 520 using the logic circuit data number as a key, and transmits the logic circuit data to the download section 620 of the client 600 (step SJ3).

When the logic circuit data are transmitted, the download section 620 issues the logic circuit data download command to the CPU 610 (step SJ4), and control returns to step SJ1.

When the logic circuit data download command is input, the CPU 610 sets the result at step SF3 shown in FIG. 11 to “Yes”, and executes the logic circuit data download process at step SF6.

Concretely, the command input section 311 (see FIG. 10) fetches the logic circuit data download command input via the command bus to the command usable/unusable determining section 314 and the command executing section 611 (step SI1 shown in FIG. 14). The operation mode retaining section 312 posts the operation modes set at this time (in this case, the operation modes 0 and 1) to the usable command retaining section 313 (step SI2).

The usable command retaining section 313 posts the command 1 (0x01) to the command n (0xf8), and the command 1 (0x11) to the command i (0xe7) corresponding respectively to the posted operation modes 0 and 1 as the usable command groups to the command usable/unusable determining section 314 (step SI3).

The command usable/unusable determining section 314 determines whether the logic circuit data download command fetched at step SI1 is usable in the operation modes 0 and 1 (step SI4). In this case, the result is assumed to be “Yes”.

At step SI5, the command executing section 611 instructs the logic circuit generating section 612 to generate a logic circuit corresponding to the logic circuit data download command (usable command) fetched at step SI1. The logic circuit generating section 612 generates the logic circuit in the command executing section 611 based on the logic circuit data corresponding to the logic circuit data download command at step SI6.

The command executing section 611 acquires the logic circuit data for setting from the download section 620 via the data input/output section 317 and the data bus, based on the logic circuit data download command and the logic circuit generated (step SI7).

The command executing section 611 sets the logic circuit data for setting in the logic circuit generating section 612 (step SI8).

Consequently, the command group is usable in the operation mode 0 added by the operation mode adding process.

On the other hand, when the result at step SI4 is “No”, namely, the logic circuit data download command fetched at step SI1 is unusable in the operation modes 0 and 1, the command usable/unusable determining section 314 processes the command as access violation error or unknown command exception (step SI9).

Thus, according to the second embodiment, the operation mode specified dynamically from the plurality of operation modes, is added into the operation mode retaining section 312, and the command corresponding to the operation, mode added is set in the usable command retaining section 313. Further, the logic circuit data that corresponds to the operation mode retained in the operation mode retaining section 312 and that is used for generating the logic circuit to be used for executing the command in the command executing section 611, are acquired from the external server 500. Therefore, while the security of information is maintained, extensibility improves, and cost reduces.

The first embodiment does not particularly explain the security of firmware downloaded from the server 100 (see FIG. 1), but using an encryption technique may strengthen the security. This case is explained below as a third embodiment.

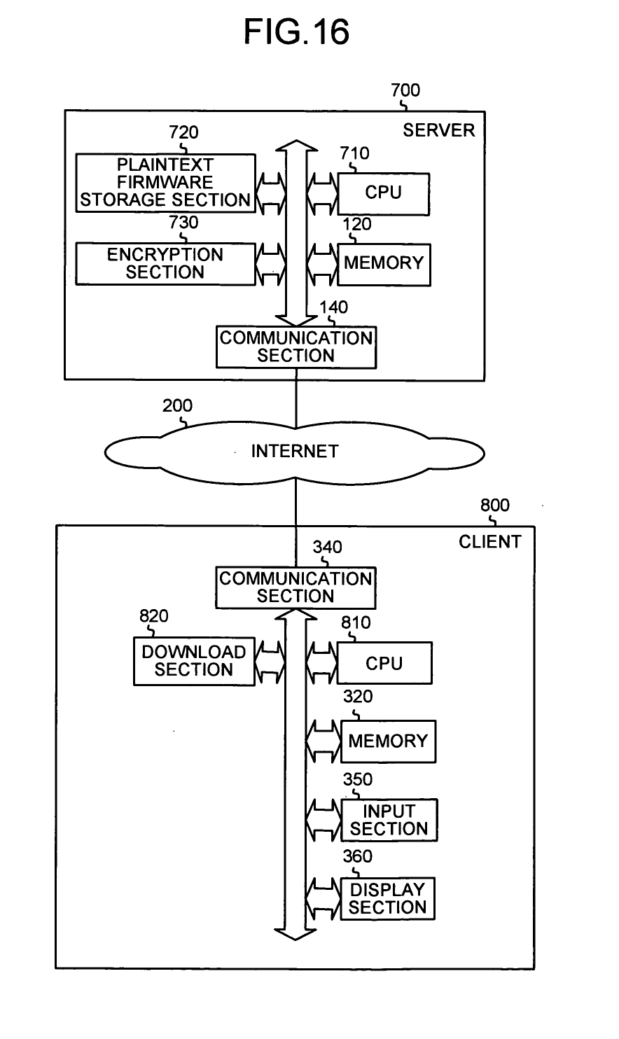

FIG. 16 is a block diagram of a system according to the third embodiment of the present invention. Portions corresponding to those in FIG. 1 are designated by identical reference numbers, and the explanation thereof is omitted.

A server 700 shown in FIG. 16 provides encrypted firmware to a client 800 via the Internet 200. In the server 700, a CPU 710 controls providing of the encrypted firmware.

A plaintext firmware storage section 720 stores plaintext firmware to be used for executing commands in a CPU 810 of a client (described later). The plaintext firmware corresponds to plaintext firmware numbers. The plaintext firmware in the third embodiment is the same as the firmware in the first embodiment.

An encryption section 730 encrypts plaintext firmware according to a RSA (Rivest Shamir Adleman) encryption system, a DES (Data Encryption Standard) encryption system or the like under control of the CPU 710, and outputs encrypted firmware.

The client 800 is connected to the Internet 200. The client 800 includes a function for downloading the encoded firmware from the server 700 via the Internet 200, a function for decrypting the encrypted firmware, and a function for executing various commands using the decrypted plaintext firmware to output results.

In the client 800, the CPU 810 controls dynamic download of the encrypted firmware, decrypts the encrypted firmware, and sets the operation modes and the command groups explained in the first embodiment.

A download section 820 downloads the encrypted firmware from the server 700 under control of the CPU 810.

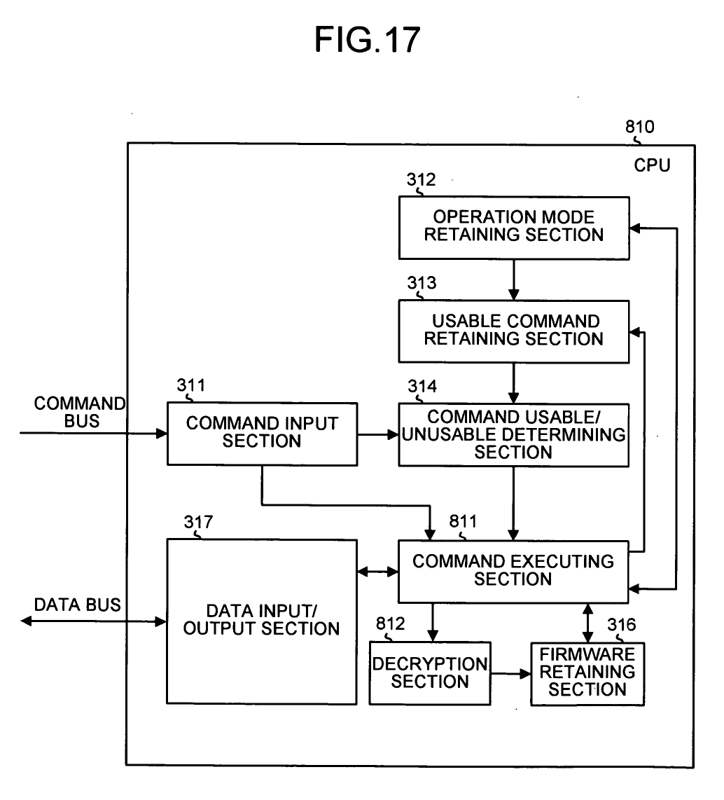

FIG. 17 is a block diagram of the CPU 810 shown in FIG. 16. Portions corresponding to those in FIG. 2 are designated by identical reference numbers, and the explanation thereof is omitted.

In the CPU 810 shown in FIG. 17, a command executing section 811 executes a command determined as usable by the command usable/unusable determining section 314. The command executing section 811 acquires the plaintext firmware to be used for executing the command from the firmware retaining section 316. A decryption section 812 decrypts the encrypted firmware downloaded by the download section 820 (see FIG. 16) under control of the command executing section 811. The firmware retaining section 316 retains the firmware decrypted as plaintext firmware.

In the third embodiment, the firmware retaining section 316 retains the plaintext firmware corresponding to the command group in the operation mode set in the operation mode retaining section 312.

The plaintext firmware is obtained by decrypting the encrypted firmware downloaded from the server 700 (see FIG. 16). Moreover, when an operation mode is added, the firmware retaining section 316 retains new plaintext firmware.

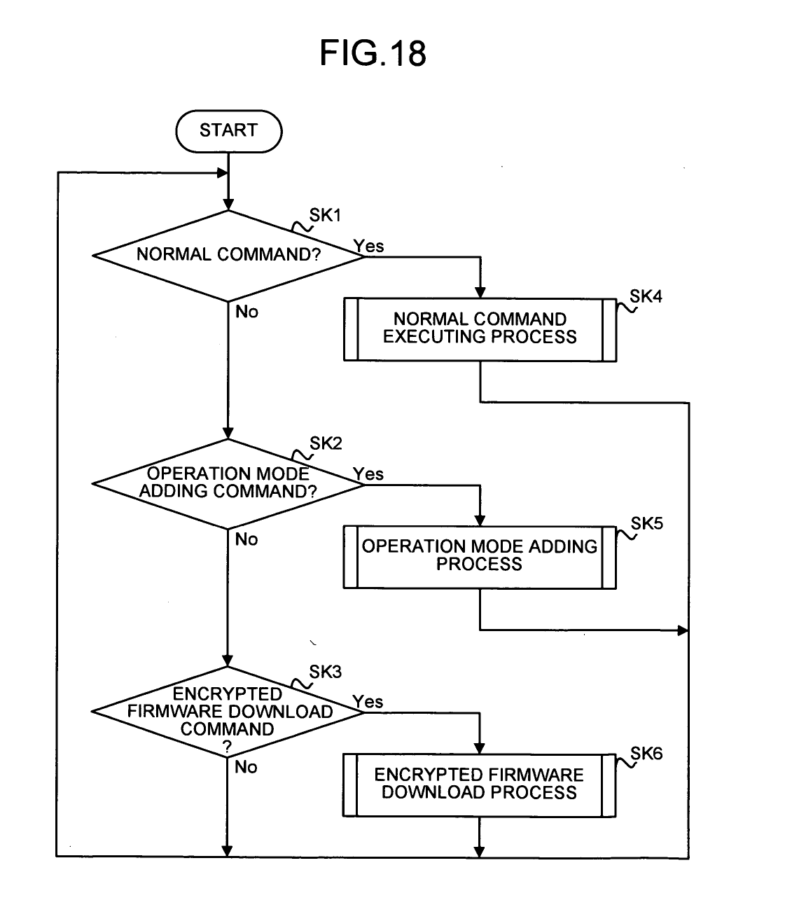

An operation of the CPU 810 according to the third embodiment is explained below with reference to flowcharts shown in FIGS. 18 to 20. The CPU 810 determines whether a normal command is input (step SK1 shown in FIG. 18) similar to step SA1 (see FIG. 4). In this case, the result is assumed to be “No”.

The CPU 810 determines whether an operation mode adding command is input (step SK2) similar to step SA2 (see FIG. 4), and in this case, the result is assumed to be “No”.

The CPU 810 determines whether an encrypted firmware download command is input (step SK3). In this case, result is assumed to be “No”, and the control goes to step SK1. The encrypted firmware download command is for downloading the encrypted firmware from the server 700 via the Internet 200. The CPU 810 repeats the steps SK1 to SK3.

If the normal command is input, the result at step SK1 is “Yes”. The CPU 810 executes the normal command executing process (see FIG. 5) at step SK4, similar to the first embodiment.

If the operation mode adding command is input, the result at step SK2 is “Yes”. The CPU 810 executes the operation mode adding process (see FIG. 6) at step SK5 similar to the first embodiment.

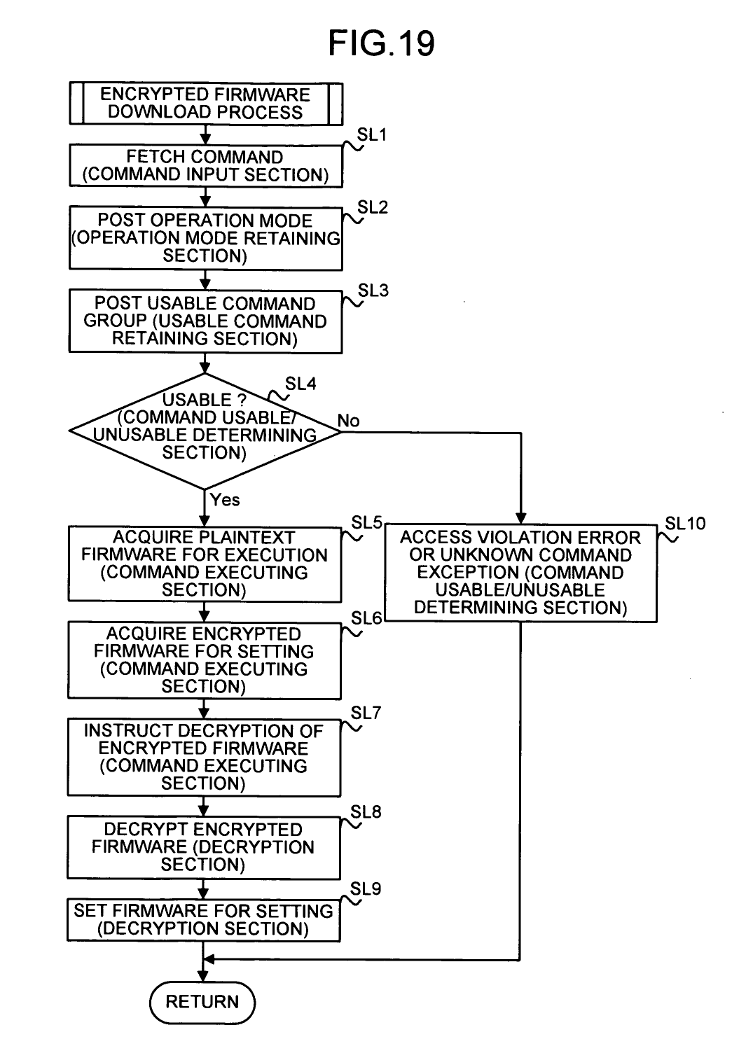

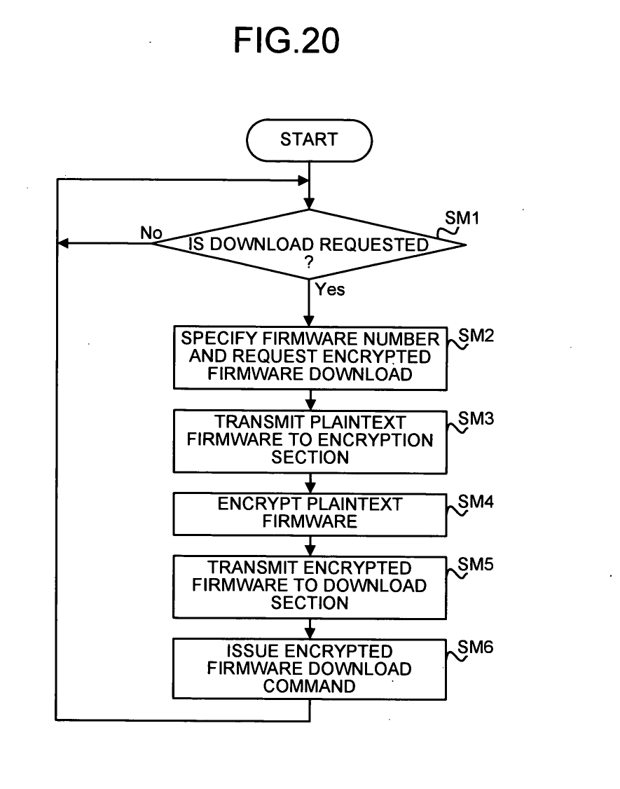

In the command group corresponding to the operation mode added by the operation mode adding process, when the plaintext firmware necessary at the time of executing the command is not retained in the firmware retaining section 316, the encrypted firmware corresponding to the plaintext firmware is downloaded from the server 700. The encrypted firmware downloading process is explained below with reference to the flowcharts in FIG. 19 and 20.

At step SM1 in FIG. 20, the download section 820 shown in FIG. 16 determines whether the CPU 810 requested for a download . In this case, the result is assumed to be “No”, and the determination is repeated.

When the CPU 810 requests the download section 820 to download the encrypted firmware, the download section 820 sets the result at step SM1 to “Yes”. The download section 820 specifies the firmware number corresponding to the encrypted firmware requested from the CPU 810 based on the firmware/firmware number table (step SM2). The download section 820 posts the encrypted firmware download request to the server 700 via the Internet 200, based on the firmware number.

Consequently, the CPU 710 of the server 700 reads the plaintext firmware from the plaintext firmware storage section 720 using the firmware number as a key, and transmits the encrypted firmware to the encryption section 730 (step SM3). The encryption section 730 encrypts the plaintext firmware according to the RSA encryption system, the .DES encryption system or the like (step SM4).

The CPU 710 transmits the encrypted firmware from the encryption section 730 to the download section 820 of the client 800 via the Internet 200 (step SM5).

When the encrypted firmware is transmitted, the download section 820 issues the encrypted firmware download command to the CPU 810 (step SM6), and control returns to step SM1.

When the encrypted firmware download command is input, the CPU 810 sets the result at step SK3 shown in FIG. 18 to “Yes”, andexecutes the encrypted firmware download process at step SK6.

Concretely, at step SL1 shown in FIG. 19, the command input section 311 (see FIG. 17) fetches the encrypted firmware download command input via the command bus to the command usable/unusable determining section 314 and the command executing section 811. The operation mode retaining section 312 posts the operation mode set at this time to the usable command retaining section 313 (step SL2).

The usable command retaining section 313 posts the command group corresponding to the posted operation mode as the usable command group to the command usable/unusable determining section 314 (step SL3).

The command usable/unusable determining section 314 determines whether the encrypted firmware download command fetched at step SL1 is usable in the operation mode (step SL4). In this case, the result is assumed to be “Yes”.

The command executing section 811 acquires the plaintext firmware corresponding to the encrypted firmware download command (usable command) fetched at step SL1 from the firmware retaining section 316 (step SL5).

The command executing section 811 acquires the encrypted firmware for setting from the download section 820 via the data input/output section 317 and the data bus, based on the encrypted firmware download command and the corresponding plaintext firmware for execution (step SL6).

The command executing section 811 instructs the decryption section 812 to decrypt the encrypted firmware (step SL7). The decryption section 812 decrypts the encrypted firmware (step SL8). The decryption section 812 sets the decrypted plaintext firmware in the firmware retaining section 316 under the control of the command executing section 811 (step SL9). Consequently, the command group is usable in the operation mode added by the operation mode adding process.

On the other hand, when the result at step SL4 is “No”, the command usable/unusable determining section 314 processes the command as access violation error or unknown command exception (step SL10).

Thus, according to the third embodiment, after the encrypted firmware is acquired from the external server 700, it is decrypted by the decryption section 812. Therefore, the security during the acquiring of the firmware strengthens.

In the third embodiment, encrypting the firmware strengthens the security. However, a digital signature technique may be used instead. This case is explained below as a fourth embodiment.

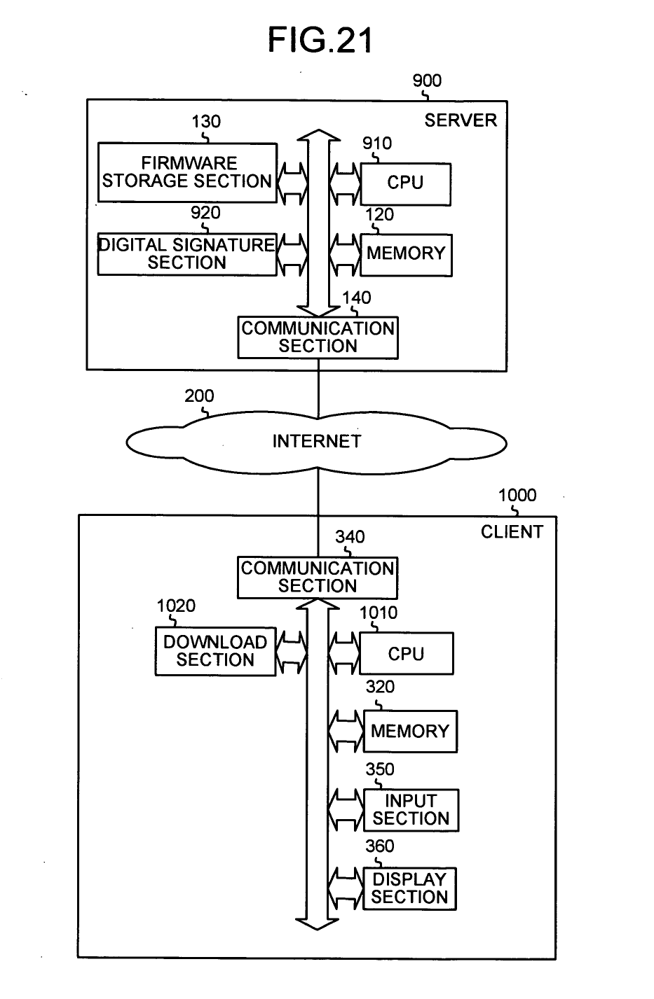

FIG. 21 is a block diagram of a system according to the fourth embodiment of the present invention. IPortions corresponding to those in FIG. 1 are designated by identical reference numbers, and the explanation thereof is omitted.

A server 900 shown in FIG. 21 provides digitally signed firmware to a client 1000 via the Internet 200. In the server 900, a CPU 910 controls the providing of the firmware with digital signature.

A digital signature section 920 generates a digitally signed firmware under control of the CPU 910. The digital signature is a security technique used to authenticate the identity of the sender of the firmware and to ensure.that the original content of the firmware that has been sent is unchanged.

The client 1000 is connected to the Internet 200. The client 1000 includes a function for downloading digitally signed firmware from the server 900 via the Internet 200, a function for certifying the digitally signed firmware, and a function for executing various commands using the certified firmware to output results.

In the client 1000, a CPU 1010 controls the dynamic download of the digitally signed firmware, authenticates the firmware, and sets the operation modes and the command groups as explained in the first embodiment.

A download section 1020 downloads the digitally signed firmware from the server 900 based on the control of the CPU 1010.

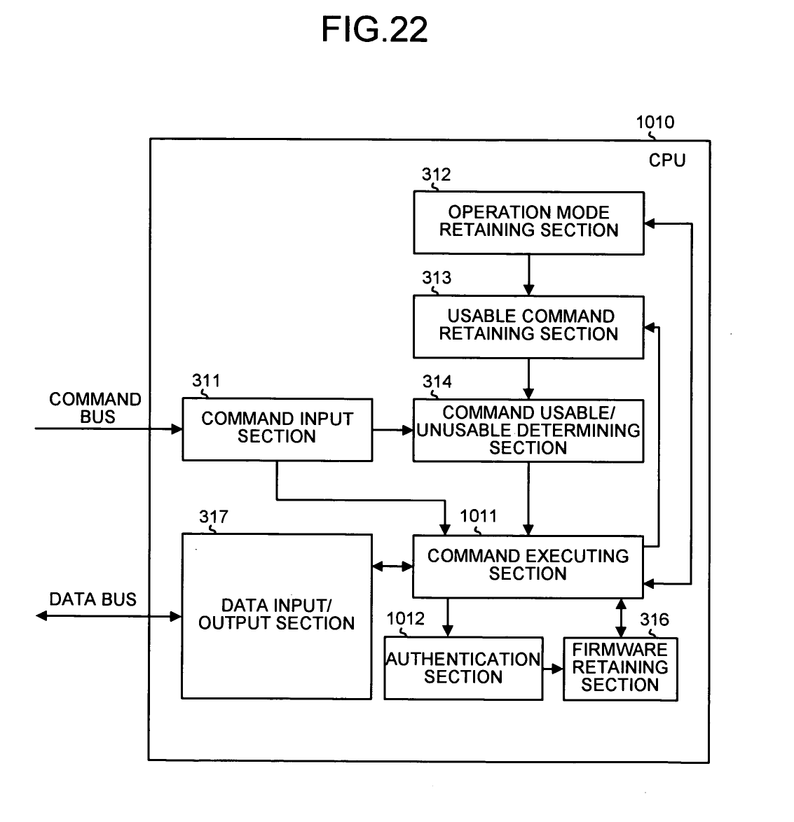

FIG. 22 is a block diagram of the CPU 1010 shown in FIG. 21. Portions corresponding to those in FIG. 2 are designated by identical reference numbers, and the explanation thereof is omitted.

In the CPU 1010 shown in FIG. 22, a command executing section 1011 executes a command determined as usable by the command usable/unusable determining section 314. Moreover, the command executing section 1011 acquires firmware to be used for executing the command, from the firmware retaining section 316. An authentication section 1012 authenticates the digitally signed firmware downloaded by the download section 1020 (see FIG. 21) under the control of the command executing section 1011. If the firmware is authentic, the firmware is retained in the firmware retaining section 316.

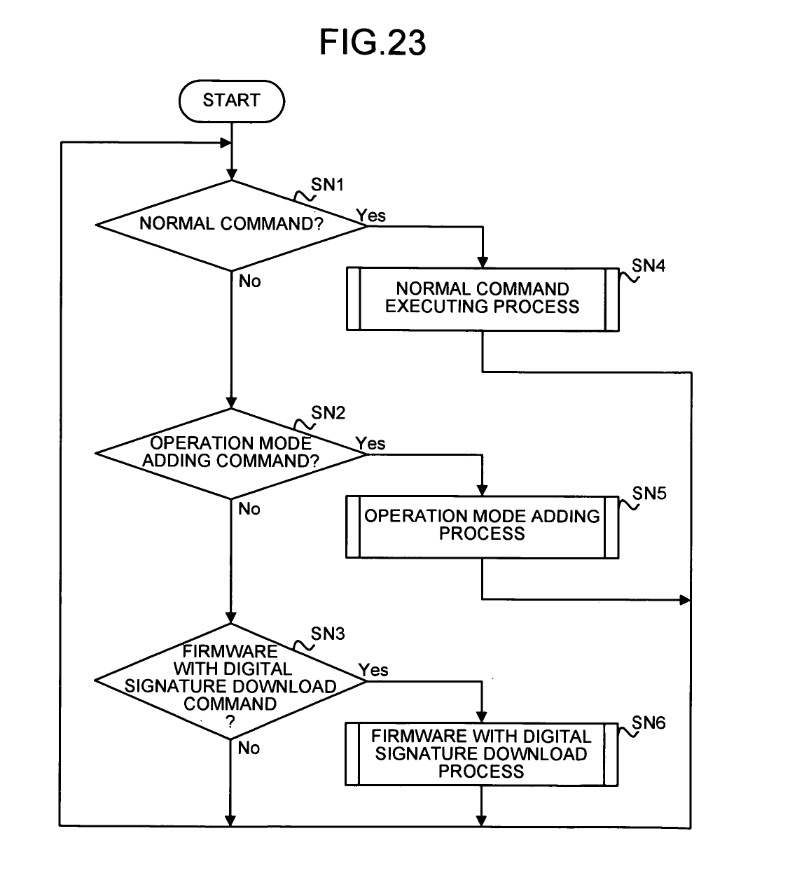

An operation of the CPU 1010 according to the fourth embodiment is explained below with reference to flowcharts shown in FIGS. 23 to 25.

The CPU 1010 determines whether a normal command is input (step SN1 shown in FIG. 23) similar to step SA1 (see FIG. 4), and in this case, the result is assumed to be “No”.

The CPU 1010 determines whether an operation mode adding command is input (step SN2) similar to step SA2 (see FIG. 4), and in this case, the result is assumed to be “No”.

The CPU 1010 determines whether a firmware with digital signature download command is input (step SN3). In this case, the result is assumed to be “No”, and the control goes to step SN1. The firmware with digital signature download command for downloading the digitally signed firmware from the server 900 via the Internet 200. Thereafter, the CPU 1010 repeats the steps SN1 to SN3.

If a normal command is input, the CPU 1010 sets the result at step SN1 to “Yes”. The CPU 1010 executes the normal command executing process at step SN4 similar to the first embodiment (see FIG. 5).

Further, if the operation mode adding command is input, the CPU 1010 sets the result at step SN2 to “Yes”. The CPU 1010 executes the operation mode adding process at step SN5 similarly to the first embodiment (see FIG. 6).

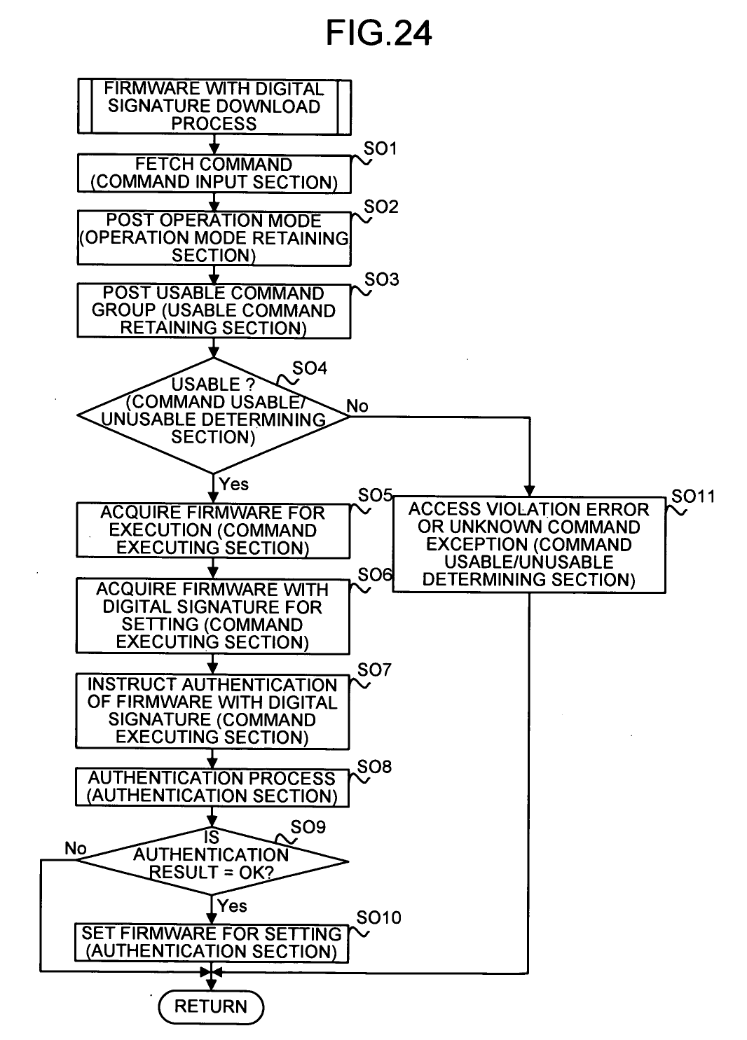

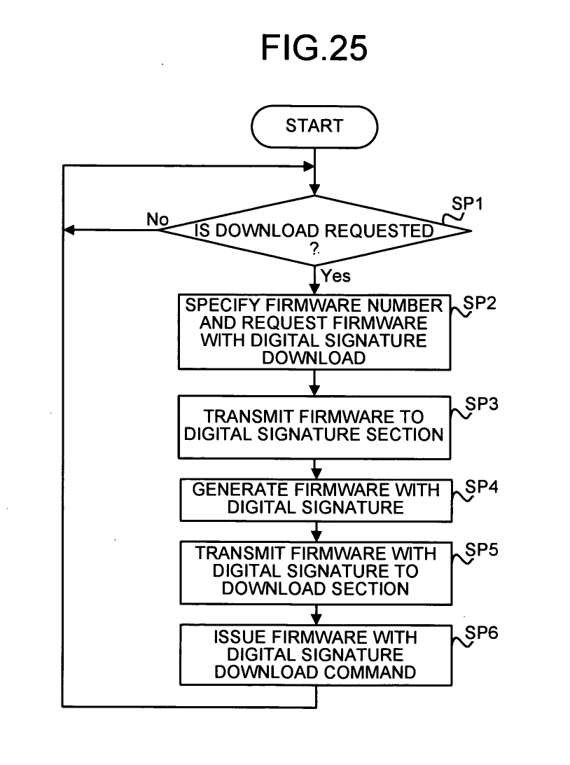

In the command group corresponding to the operation mode added by the operation mode adding process, when the firmware necessary for executing the command is not retained in the firmware retaining section 316, the digitally signed firmware corresponding to the firmware is downloaded from the server 900. The firmware with digital signature download process is explained below with reference to the flowcharts in FIGS. 24 and 25.

At step SP1 in FIG. 25, the download section 1020 shown in FIG. 21 determines whether the CPU 1010 requested for the download. In this case, the result is assumed to be “No”, and the determination is repeated.

When the CPU 1010 requests the download section 1020 to download the digitally signed firmware, the download section 1020 sets the result at step SP1 to “Yes”. The download section 1020 specifies a firmware number corresponding to the firmware requested by the CPU 1010 based on the firmware/firmware number table (step SP2). The download section 1020 posts the firmware with digital signature download request to the server 900 via the Internet 200, based on the firmware number.

Consequently, the CPU 910 of the server 900 reads the firmware from the firmware storage section 130 using the firmware number as a key, and transmits the firmware to the digital signature section 920 (step SP3). The digital signature section 920 generates the digitally signed firmware (step SP4).

The CPU 910 transmits the digitally signed firmware from the digital signature section 920 to the download section 1020 of the client 1000 via the Internet 200 (step SP5).

When the digitally signed firmware is transmitted, the download section 1020 issues the firmware with digital signature download command to the CPU 1010 (step SP6), and control returns to step SP1.

When the firmware with digital signature download command is input, the CPU 1010 sets the result at step SN3 shown in FIG. 23 to “Yes”, and executes the firmware with digital signature download process at step SN6.

Concretely, at step SO1 shown in FIG. 24, the command input section 311 (see FIG. 22) fetches the firmware with digital signature download command input via the command bus to the command usable/unusable determining section 314 and the command executing section 1011. The operation mode retaining section 312 posts the operation mode set at this time to the usable command retaining section 313 (step SO2).

The usable command retaining section 313 posts the command group corresponding to the operation mode posted, as the usable command group, to the command usable/unusable determining section 314 (step SO3).

The command usable/unusable determining section 314 determines whether the firmware with digital signature download command fetched at step SO1 is usable in the operation mode (step SO4). In this case, the result is assumed to be “Yes”.

The command executing section 1011 acquires the firmware the firmware with digital signature download command (usable command) fetched at step SO1 from the firmware retaining section 316 (step SO5).

The command executing section 1011 acquires the digitally signed firmware for setting from the download section 1020 via the data input/output section 317 and the data bus, based on the firmware with digital signature download command and the corresponding firmware for execution (step SO6).

The command executing section 1011 instructs the authentication section 1012 to authenticate the digitally signed firmware (step SO7). The authentication section 1012 authenticates the digitally signed firmware (step SO8), and posts an authentication result to the command executing section 1011. The command executing section 1011 determines whether the authentication result is OK (step SO9).

When the authentication result is NG, namely, the firmware for setting is tampered, the command executing section 1011 sets the result at step SO9 to “No”. The command executing section 1011 then cancels the setting, and returns to the main routine shown in FIG. 23.

On the other hand, when the authentication result is OK, the command executing section 1011 sets the result at step SO9 to “Yes”. The authentication section 1012 stores the firmware in the firmware retaining section 316 under the control of the command executing section 1011 (step SO10). Consequently, the command group is usable in the operation mode added by the operation mode adding process.

On the other hand, when the result at step SO4 is “No”, the command usable/unusable determining section 314 processes the command as access violation error or unknown command exception (step SO11).

Thus, according to the fourth embodiment, the digitally signed firmware is acquired from the external server 900, and authenticated by the authentication section 1012. Therefore, it is assured that the firmware acquired is unaltered.

The first embodiment does not particularly explain access control to resources such as encryption key, signature key, certificate contained in the CPU at the time of executing the command. However, access to these resources may be controlled. This case is explained below as a fifth embodiment.

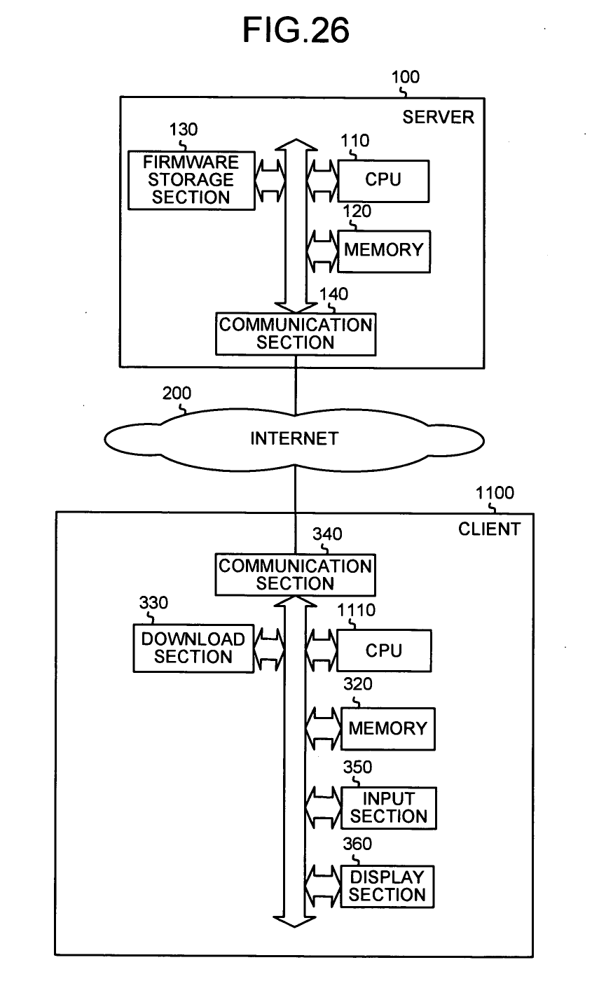

FIG. 26 is a block diagram of a system according to the fifth embodiment. Portions corresponding to those in FIG. 1 are designated by identical reference numbers, and the explanation thereof is omitted.

A client 1100 shown in FIG. 26 is connected to the Internet 200. The client 1100 includes a function for downloading firmware from the server 100 via the Internet 200, and a function for executing various commands using the firmware to output results.

In the client 1100, a CPU 1110 controls dynamic download of the firmware, sets operation modes and command groups, (described later), and controls access to the resources mentioned above.

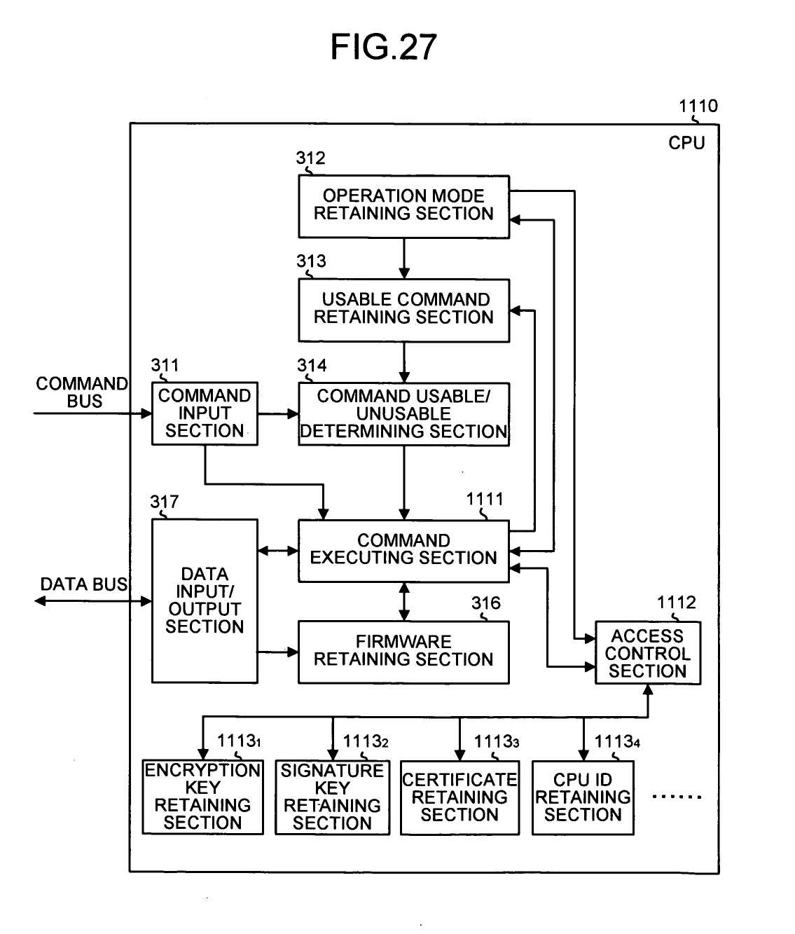

FIG. 27 is a block diagram of the CPU 1110 shown in FIG. 26. Portions corresponding to those in FIG. 2 are designated by identical reference numerals, and the explanation thereof is omitted. A command executing section 1111 executes a command determined as usable by the command usable/unusable determining section 314. The command executing section 1111 acquires firmware for executing the command, from the firmware retaining section 316. Further, the command executing section 1111 accesses resources in the CPU 1110 (encryption key, signature key, and the like) based on a type of the command. For example, when the command is an encryption command, the command executing section 1111 accesses the encryption key, and encrypts data using the encryption key.

Encryption keys, signature keys, certificates, CPU Ids, etc. are retained in an encryption key retaining section 11131, a signature key retaining section 11132, a certificate retaining section 11133, a CPU ID retaining section 11134, etc. respectively. For example, the encryption keys are used when data are encrypted. The signature keys are used when data is digitally signed.

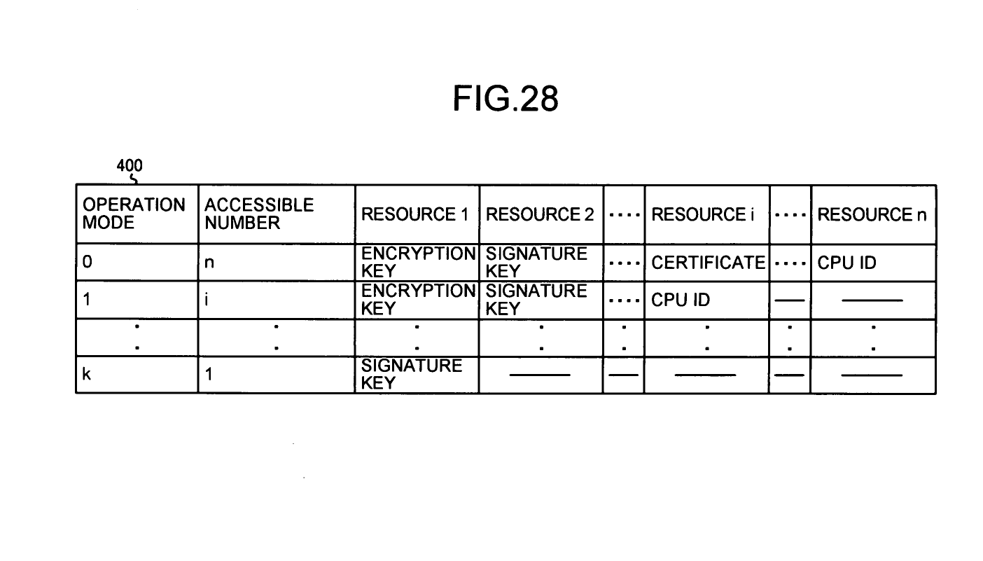

When the command executing section 1111 accesses the resources, an access control section 1112 determines whether the access is permitted based on the operation mode in an operation mode/resource table 1200 shown in FIG. 28.

In the operation mode/resource table 1200, the operation modes “0” to “k” correspond to the operation modes in the operation mode/command table 400 (see FIG. 3).

For each operation mode, a number of resources accessible by the command executing section 1111 in the operation mode is set.

For example, in the case of the operation mode 0, the accessible number is n. That is, in the operation mode 0, the command executing section 1111 can access n types of resources including a resource 1 (encryption key) to a resource n (CPU ID).

In the operation mode 1, the accessible number is i. That is, in the operation mode 1, the command executing section 1111 can access i types of resources including the resource 1 (encryption key) to a resource i (CPU ID).

Similarly, in the operation mode k, the command executing section 1111 can access the resource 1 (signature key). Further, when only the operation mode k is set, the command executing section 1111 cannot access resources other than the resource 1 (signature key).

An operation of the CPU 1110 according to the fifth embodiment is explained below with reference to the flowcharts shown in FIG. 4 and FIGS. 29 to 31. The CPU 1110 determines whether a normal command is input (step SA1 in FIG. 4), and in this case, the result is assumed to be “No”. The CPU 1110 determines whether an operation mode adding command is input (step SA2), and in this case, the result is assumed to be “No”.

The CPU 1110 determines whether a firmware download command is input (step SA3), and in this case, the result is assumed to be “No”. Thereafter, the CPU 1110 repeats the steps SA1 to SA3.

If the normal command is input, the CPU 1110 sets the determined result at step SA1 to “Yes”, and executes the normal command executing process at step SA4.

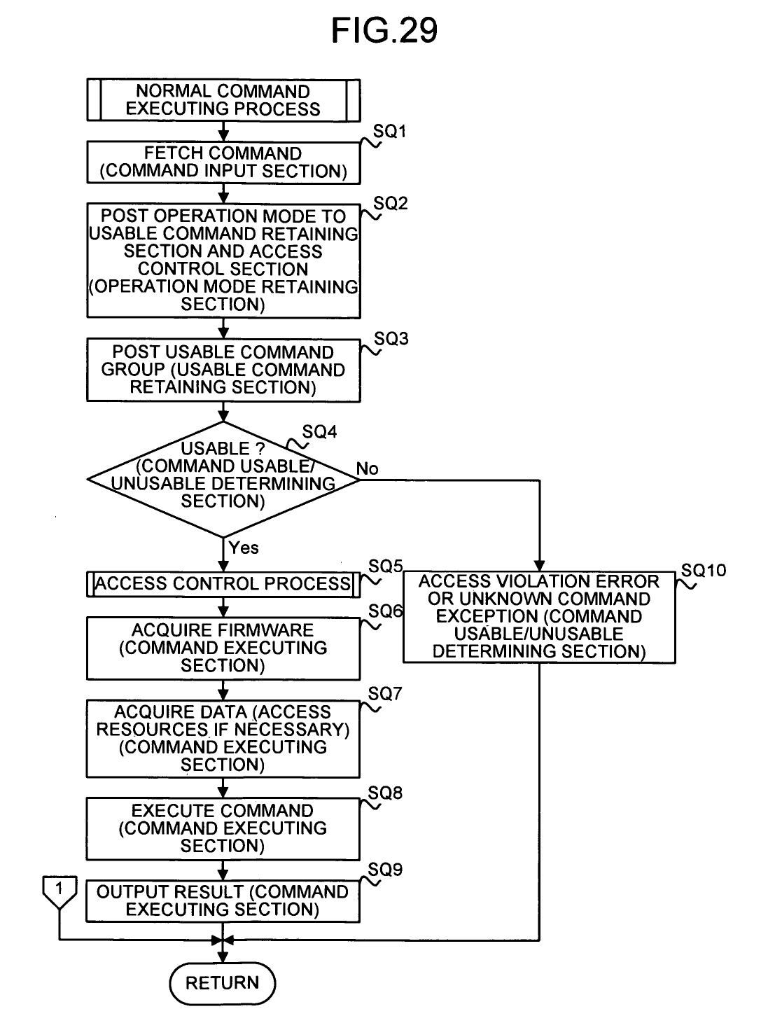

FIG. 29 is a flowchart of the normal command executing process. The command input section 311 (see FIG. 27) fetches the normal command input via the command bus to the command usable/unusable determining section 314 and the command executing section 1111 (step SQ1). The operation mode retaining section 312 posts the operation mode set at this time to the usable command retaining section 313 and the access control section 1112 (step SQ2). The operation mode posted is “1” as shown in FIGS. 3 and 28.

The usable command retaining section 313 posts the command group corresponding to the operation mode posted, as the usable command group, to the command usable/unusable determining section 314 (step SQ3). The usable command group in this case includes the command 1 (0x11) to the command i (0xe7) corresponding to the operation mode 1 as shown in FIG. 3.

The command usable/unusable determining section 314 determines whether the normal command fetched at step SQ1 is usable in the operation mode (step SQ4). Concretely, the command usable/unusable determining section 314 determines whether the usable command group posted at step SQ3 includes the normal command fetched at step SQ1. In this case, the result is assumed to be “Yes”.

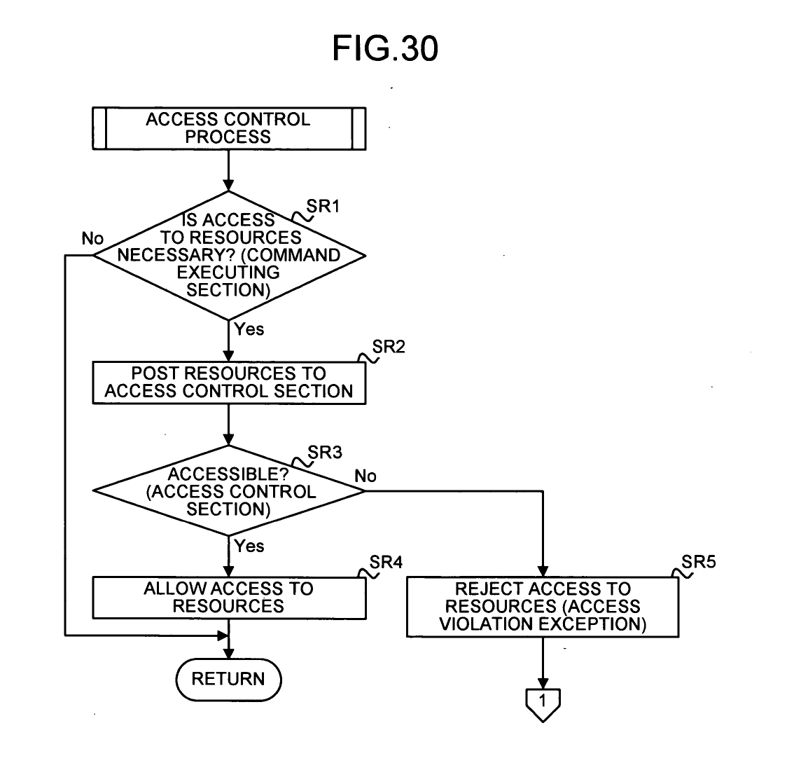

An access control process is executed at step SQ5 so that the access from the command executing section 1111 to the resources (encryption keys, signature keys, certificate, CPU IDs, and the like) is controlled. Concretely, the command executing section 1111 determines whether the access to the resources is necessary at the time of executing the normal command (step SR1 shown in FIG. 30).

In this case, the normal command is encrypted, and thus the encryption key is necessary. The command executing section 1111, therefore, sets the result at step SR1 to “Yes”. However, if the result at step SR1 is “No”, the command executing section 1111 returns to step SQ6 shown in FIG. 29.

When the resource (encryption key) needs to be accessed, the command executing section 1111 posts the resource (encryption key) to the access control section 1112 (step SR2). At step SR3, the access control section 1112 refers to the operation mode/resource table 1200 (see FIG. 28) to determine whether the command executing section 1111 can access the resource (encryption key) posted at step SR2, in the current operation mode 1.

Concretely, the access control section 1112 determines whether the resource 1 (encryption key) to the resource i (CPU ID) corresponding to the operation mode 1 shown in FIG. 28 include the resource (encryption key) posted at step SR2. In this case, the result is assumed to be “Yes”. The access control section 1112 allows the command executing section 1111 to access the resource (encryption key) (step SR4).

On the other hand, if the result at step SR3 is “No”, the access control section 1112 does not allow the command executing section 1111 to access the resource (encryption key) (step SR5). The access control section 1112 processes the access as access violation exception.

When control returns to FIG. 29, the command executing section 1111 acquires firmware corresponding to the normal command (usable command) fetched at step SQ1 from the firmware retaining section 316 (step SQ6).

The command executing section 1111 acquires data required for executing the command from the data input/output section 317 (step SQ7). In this case, the command executing section 1111 acquires the encryption key stored in the encryption key retaining section 11131.

At step SQ8, the command executing section 1111 executes the normal command using the firmware, the data and the resource (encryption key). The command executing section 1111 outputs the result of execution via the data input/output section 317 (step SQ9).

On the other hand, when the result at step SQ4 is “No”, namely, the normal command fetched at step SQ1 is unusable in the operation mode 1, the command usable/unusable determining section 314 processes the normal command as access violation error or unknown command exception (step SQ10).

The operation mode adding process is explained next. If the operation mode adding command is input, the CPU 1110 sets the result at step SA2 shown in FIG. 4 to “Yes”, and executes the operation mode adding process at step SA5.

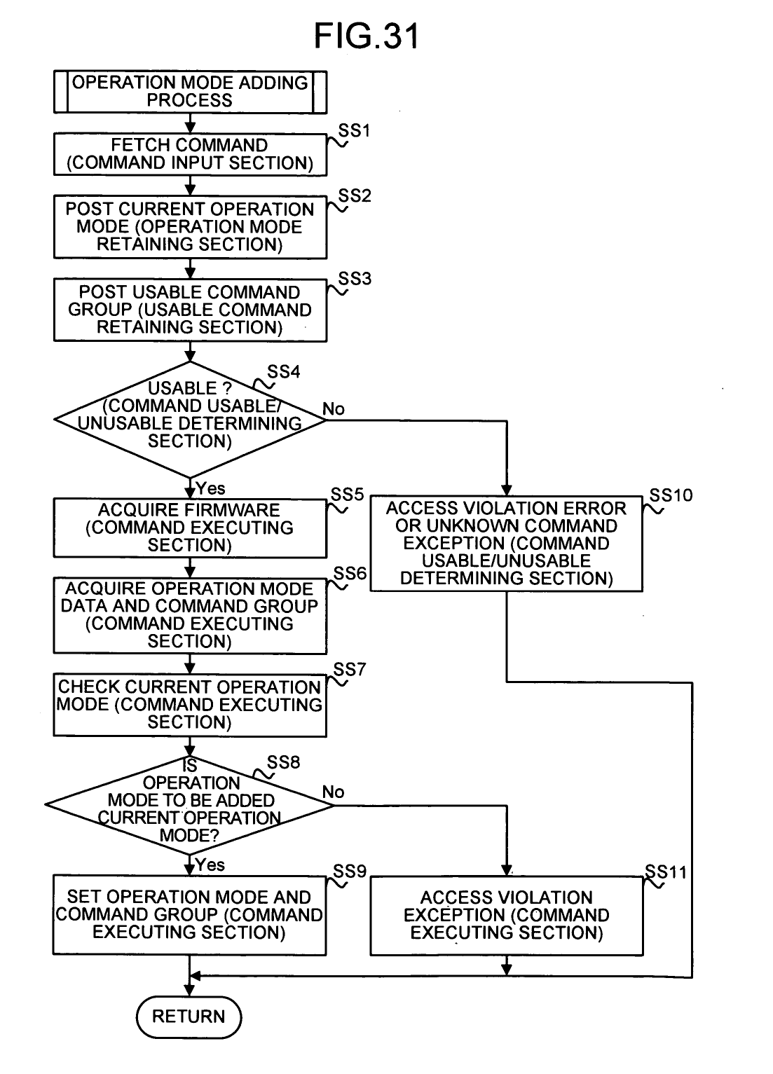

Concretely, at step SS1 shown in FIG. 31, the command input section 311 (see FIG. 27) fetches the operation mode adding command input via the command bus to the command usable/unusable determining section 314 and the command executing section 1111. The operation mode retaining section 312 posts the operation mode set at this time (in this case, the operation mode 1) to the usable command retaining section 313 (step SS2).

The usable command retaining section 313 posts the command 1 (0x11) to the command i (0xe7) corresponding to the posted operation mode 1 as the usable command group, to the command usable/unusable determining section 314 (step SS3).

The command usable/unusable determining section 314 determines whether the operation mode adding command fetched at step SS1 is usable in the operation mode (step SS4). In this case, the result is assumed to be “Yes”.

If the result at step SS4 is “No”, namely, the operation mode adding command fetched at step SS1 is unusable in the operation mode 1, the command usable/unusable determining section 314 processes the command as access violation error or unknown command exception (step SS1O).

Whereas, if the result at step SS4 is “Yes”, the command executing section 1111 acquires the firmware corresponding to the operation mode adding command (usable command) fetched at step SS1 from the firmware retaining section 316 (step SS5).

The command executing section 1111 acquires the operation mode data and the command group of the operation mode to be added, from the data input/output section 317 (step SS6). In this case, the operation mode data are “0” (see FIG. 3) corresponding to the operation mode to be added. Further, the command group includes the command 1 (0x01) to the command n (0xf8) corresponding to the operation mode 0, as shown in FIG. 3.

The command executing section 1111 checks the operation mode set at this time (1) in the operation mode retaining section 312 (step SS7). The command executing section 1111 determines whether the operation mode to be added (0) is less than the current operation mode (1) (step SS8). In other words, the command executing section 1111 determines whether the number of usable commands increases after adding the operation mode.

That is to say, the command executing section 1111 determines whether the number of the commands in the operation mode dynamically specified and that is to be added, is greater than the number of the commands in the operation mode retained in the operation mode retaining section 312 (see FIG. 27).

In this case, the command executing section 1111 sets the determined result at step SS8 to “Yes”. The command executing section 1111 sets the operation mode 0 into the operation mode retaining section 312, and sets the command group corresponding to the operation mode 0 in the usable command retaining section 313 (step SS9). Consequently, the command group is usable in the operation mode 0.

On the other hand, when the result at step SS8 is “No”, the command executing section 1111 does not add the operation mode, and processes this command as access violation error or unknown command exception (step SS11).

When the firmware download command is input, the CPU 1110 sets the determined result at step SA3 shown in FIG. 4 to “Yes”. The CPU 1110 executes the firmware download process (see FIG. 7) at step SA6 similar to the first embodiment.

Thus, according to the fifth embodiment, based on the operation mode, the access control section 1112 controls the access to the various resources such as encryption key, signature key, certificate, CPU ID and the like, which are to be used during execution of the command. Therefore, the resources can be dynamically allocated depending on the operation mode.

Moreover, the number of commands in the operation mode dynamically specified and that is to be added, is larger than the number of commands in the operation mode already retained in the operation mode retaining section 312 (see FIG. 27). Only in this case, the dynamically specified operation mode is added into the operation mode retaining section 312. Thus, adding an operation mode under strict conditions further strengthens security.

In the first embodiment, the CPU instructs adding of an operation mode or downloading of firmware. However, the addition of operation mode or the firmware download may be instructed by an operating system external to the CPU 310 (see FIG. 1). This case is explained below as a sixth embodiment.

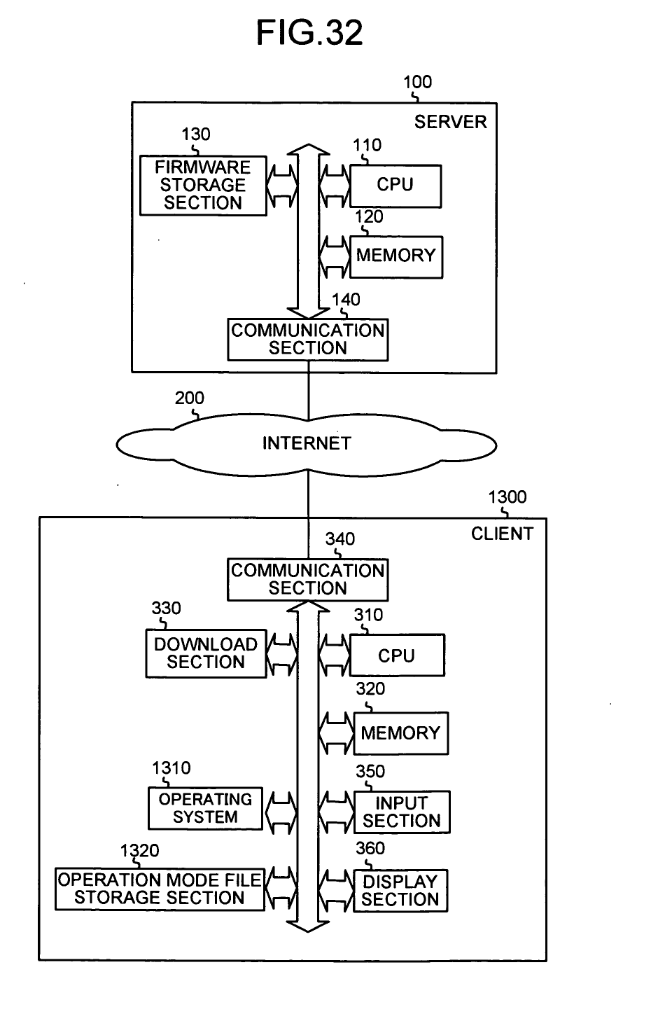

FIG. 32 is a block diagram of a constitution according to the sixth embodiment of the present invention. Portions corresponding to those in FIG. 1 are designated by identical reference numbers. A client 1300 shown in FIG. 32 is connected to the Internet 200. The client 1300 includes a function for downloading firmware from the server 100 via the Internet 200, and a function for executing various commands using firmware to output results.

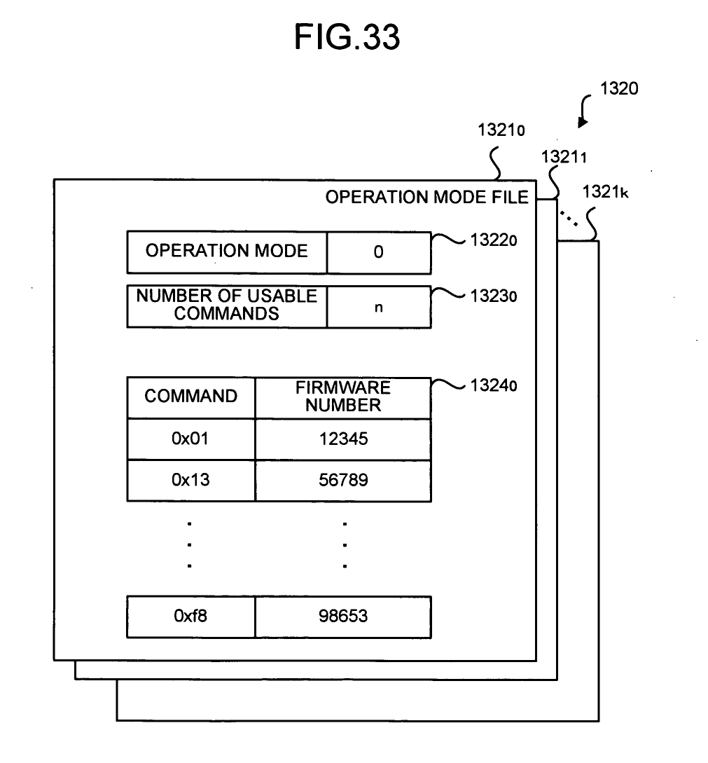

In the client 1300, an operating system 1310 instructs the addition of operation mode and the firmware download. An operation mode file storage section 1320 stores operation mode files 13210 to 1321k shown in FIG. 33. The operation mode files 13210 to 1321k correspond to the operation mode/command table 400 shown in FIG. 3.

The operation mode file 13210 contains operation mode data 13220, data about the number of usable commands 13230, and command/firmware number data 13240. The operation mode data 13220 represent the operation mode 0 shown in FIG. 3.

The data about number of usable commands 13230 represent the number of usable commands n shown in FIG. 3. The command/firmware number data 13240 include the commands 1 (0x01) to the command n (0xf8) shown in FIG. 3, and firmware numbers for specifying firmware corresponding to the commands.

The operation mode files 13211 to 1321k have the same data structure as that of the operation mode file 13210, and contain the data about the operation modes 1 to k.

In the sixth embodiment, the download section 330 shown in FIG. 32 does not issue the firmware download command, but performs the download function. The firmware download command is issued by the operation system 1310.

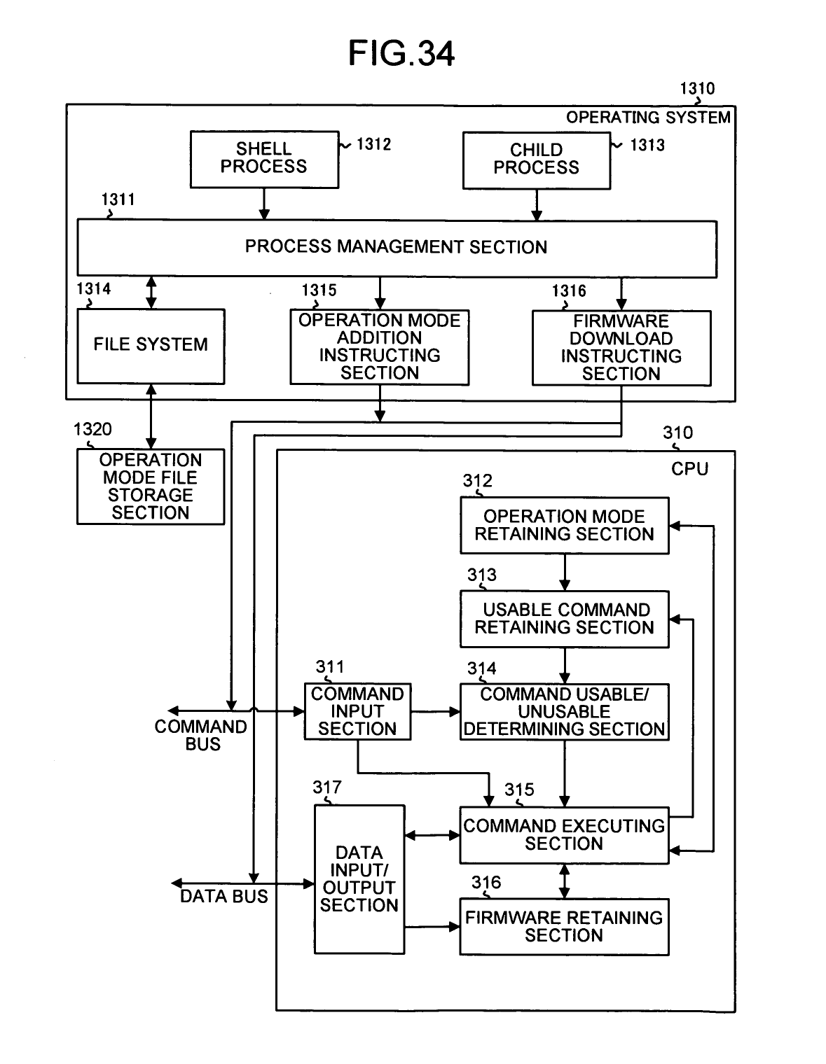

FIG. 34 is a block diagram of the operating system 1310 and the CPU 310 shown in FIG. 32. Portions corresponding to those in FIGS. 2 and 32 are designated by identical reference numbers, and the explanation thereof is omitted.

In the operating system 1310 shown in FIG. 34, a process management section 1311 manages a shell process 1312 (addition of operation mode, firmware download, and the like), and a child process 1313.

A file system 1314 reads an operation mode file from the operation mode file storage section 1320 under the control of the process management section 1311. An operation mode addition instructing section 1315 instructs the addition of operation mode in the CPU 310 under the control of the process management section 1311.

A firmware download instructing section 1316 instructs the firmware download from the.server 100 (see FIG. 32) under the control of the process management section 1311.

An operation of the CPU 1310 according to the sixth embodiment is explained below with reference to flowcharts shown in FIGS. 4 to 8 and 35. The CPU 310 determines whether a normal command is input (step SA1 shown in FIG. 4), and in this case, the result is assumed to be “No”.

The CPU 310 determines whether the operation mode adding command is input (step SA2), and in this case, the result is assumed to be “No”. The CPU 310 determines whether a firmware download command is input (step SA3). In this case, the result is assumed to be “No”, and the steps SA1 to SA3 are repeated.

If the normal command is input, the CPU 310 sets the result at step SA1 to “Yes”. The CPU 310 executes the normal command executing process (see FIG. 5) at step SA4 similar to the first embodiment.

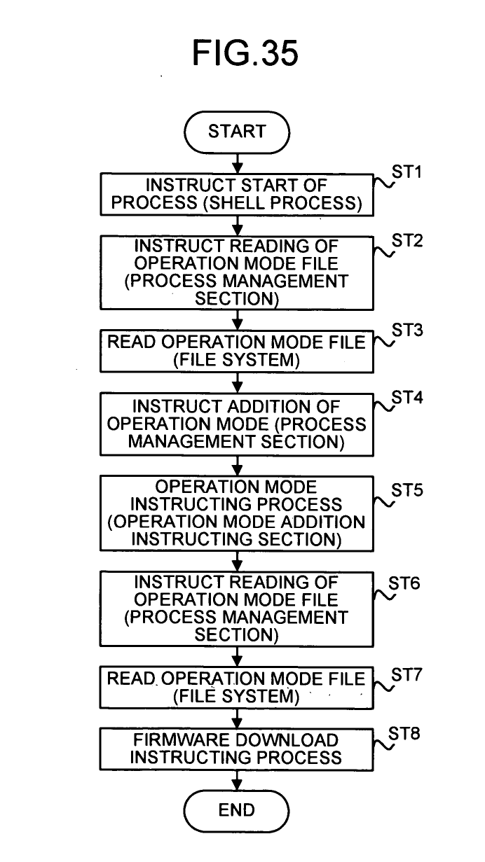

When the operation mode (for example, the operation mode 0) is added, the shell process 1312 of the operating system 1310 shown in FIG. 34 instructs the process management section 1311 to start the process at step ST1 shown in FIG. 35.

The process management section 1311 instructs the file system 1314 to read the operation mode file 13210 corresponding to the operation mode 0 to be added, from the operation mode file storage section 1320 shown in FIG. 33 (step ST2).

The file system 1314 reads the operation mode file 13210 from the operation mode file storage section 1320 (step ST3). The process management section 1311 instructs the operation mode addition instructing section 1315 to add the operation mode 0 (step ST4). The operation mode addition instructing section 1315 issues the operation mode adding command as the operation mode instructing process to the CPU 310 (step ST5).

When the operation mode adding command is input, the CPU 310 sets the result at step SA2 shown in FIG. 4 to “Yes”. The CPU 310 executes the operation mode adding process at step SA5.

Concretely, the command input section 311 (see FIG. 34) fetches the operation mode adding command input via the command bus to the command usable/unusable determining section 314 and the command executing section 315 at step SC1 shown in FIG. 6.

The operation mode retaining section 312 posts the operation mode set at this time (in this case, the operation mode 1) to the usable command retaining section 313 (step SC2).

The usable command retaining section 313 posts the usable command group corresponding to the posted operation mode 1 to the command usable/unusable determining section 314 (step SC3).

The command usable/unusable determining section 314 determines whether the operation mode adding command fetched at step SC1 is usable in the operation mode (step SC4). In this case, a result is assumed to be “Yes”.

The command executing section 315 acquires the firmware corresponding to the operation mode adding command (usable command) fetched at step SC1 from the firmware retaining section 316 (step SC5).

The command executing section 315 acquires the operation mode data and the command group from the data input/output section 317 (step SC6). In this case, the operation mode data are “0” (see FIG. 3) corresponding to the operation mode to be added. The command group includes the command 1 (0x01) to the command n (0xf8) corresponding to the operation mode 0 as shown in FIG. 3.

The command executing section 315 sets the operation mode 0 to be added, into the operation mode retaining section 312, and sets the command group corresponding to the operation mode 0 into the usable command retaining section 313 (step SC7). Consequently, the command group is usable in the operation mode 0.

At step ST6 in FIG. 35, the processing management section 1311 instructs the file system 1314 to read the operation mode file 13210 corresponding to the operation mode 0 added, from the operation mode file storage section 1320 shown in FIG. 33.

The file system 1314 reads the operation mode file 13210 shown in FIG. 33 from the operation mode file storage section 1320 (step ST7). The process management section 1311 sends the command/firmware number data 13240 of the operation mode file 13210 to the firmware download instructing section 1316 and instructs the download of the firmware (step ST8).

Consequently, the firmware download instructing section 1316 issues the firmware download command to the CPU 310, and sends the command/firmware number data 13240 to the data input/output section 317.

When the firmware download command is input, the CPU 310 sets the result at step SA3 shown in FIG. 4 to “Yes”. The CPU 310 executes the firmware download process at step SA6.

Concretely, the command input section 311 (see FIG. 34) fetches the firmware download command input via the command bus to the command usable/unusable determining section 314 and the command executing section 315 at step SD1 shown in FIG. 7. The operation mode retaining section 312 posts the operation mode set at this time to the usable command retaining section 313 (step SD2).

The usable command retaining section 313 posts the usable command group corresponding to the operation mode posted, to the command usable/unusable determining section 314 (step SD3).

The command usable/unusable determining section 314 determines whether the firmware download command fetched at step SD1 is usable in the operation mode (step SD4). Concretely, the command usable/unusable determining section 314 determines whether the usable command group posted at step SD3 includes the firmware download command fetched at step SD1. In this case, a result is assumed to be “Yes”.

The command executing section 315 acquires the firmware for execution corresponding to the firmware download command (usable command) fetched at step SD1 from the firmware retaining section 316 (step SD5).

Based on the firmware download command and the corresponding firmware for execution, the command executing section 315 acquires the firmware for setting, from the download section 330 via the data input/output section 317 and the data bus (step SD6).

Concretely, the command executing section 315 sends the command/firmware number data 13240 (see FIG. 33) and the download request to the download section 330 shown in FIG. 32. Consequently, the download section 330 sets the result at step SE1 shown in FIG. 8 to “Yes”.

Based on the command/firmware number data 13240, the download section 330 specifies the firmware number corresponding to the firmware requested (step SE2). Based on the firmware number, the download section 330 requests the server 100 to download the firmware via the Internet 200.

Consequently, the CPU 110 of the server 100 reads the firmware from the firmware storage section 130 using the firmware number as a key, and transmits the firmware to the download section 330 of the client 1300 (step SE3). In the sixth embodiment, the step SE4 is skipped.

The command executing section 315 shown in FIG. 34 acquires the firmware for setting from the download section 330.

With reference to FIG. 7, the command executing section 315 sets the firmware for setting in the firmware retaining section 316 (step SD7). Consequently, the command group is usable in the operation mode added by the operation mode adding process.

Thus, according to the sixth embodiment, the same effect as that in the first embodiment is obtained.

The sixth embodiment explains a case in which the operating system external to the CPU 310 (see FIG. 32) instructs the addition of operation mode and the firmware download. In addition, the operating system may instruct deletion of operation mode and firmware unload. This case is explained below as a seventh embodiment.

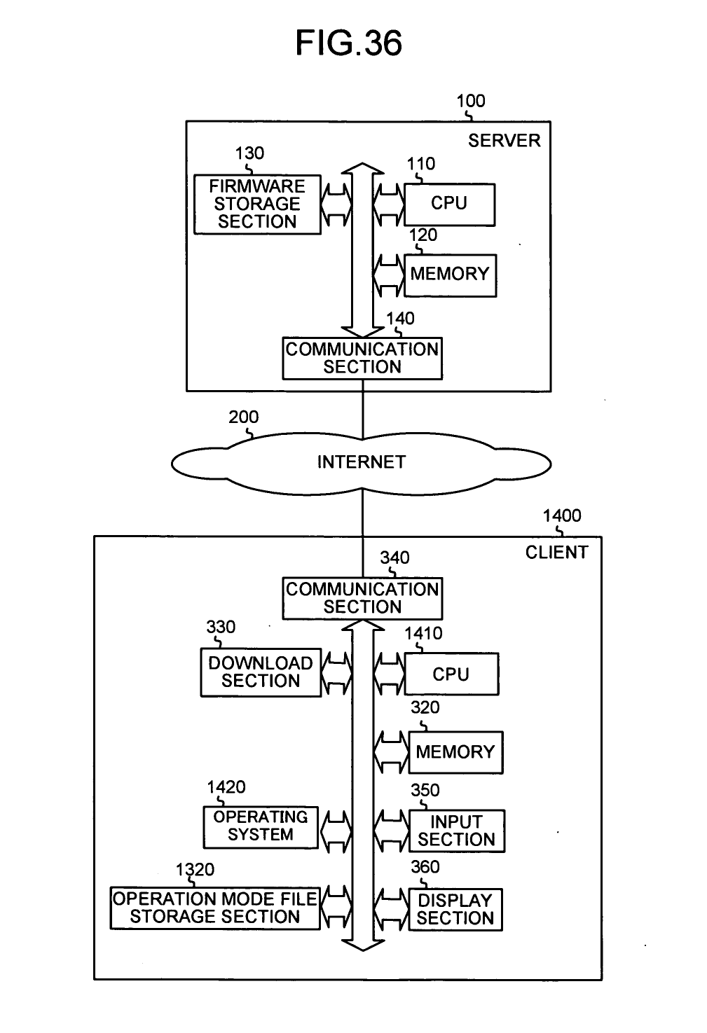

FIG. 36 is a block diagram of a constitution according to the seventh embodiment of the present invention. Portions corresponding to those in FIG. 32 are designated by identical reference numbers. A client 1400 shown in FIG. 36 is connected to the Internet 200. The client 1400 includes a function for downloading firmware from the server 100 via the Internet 200, a function for unloading firmware, and a function for executing various commands using firmware to output results.

In the client 1400, an operating system 1420 instructs the addition of operation mode, the deletion of operation mode, the firmware download, and the firmware unload.

In the seventh embodiment, the download section 330 shown in FIG. 36 does not issue the firmware download command but performs the download function. The firmware download command is issued by the operating system 1420.

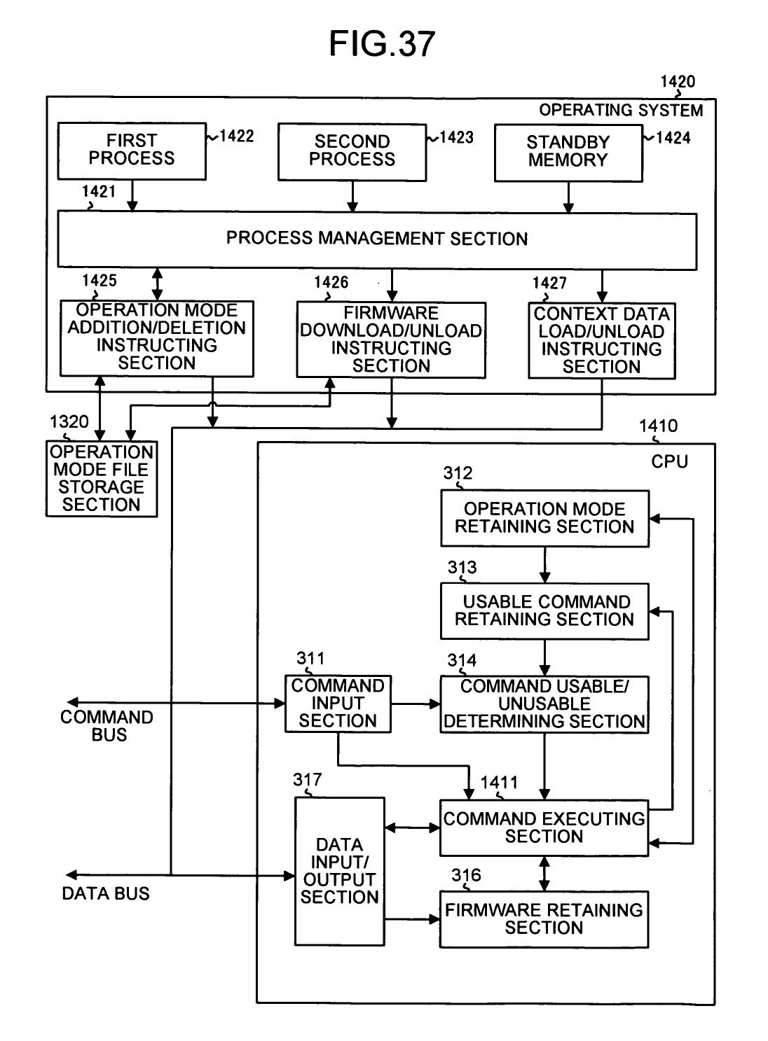

FIG. 37 is a block diagram of the operating system 1420 and a CPU 1410 shown in FIG. 36. Portions corresponding to those in FIG. 34 are designated by identical reference numerals, and the explanation thereof is omitted.

In the operating system 1420 shown in FIG. 37, a process management section 1421 manages a first process 1422 and a second process 1423. A standby memory 1424 temporarily saves data under the control of the process management section 1421.

An operation mode addition/deletion instructing section 1425 instructs addition and deletion of operation mode in the CPU 1410 under the control of the process management section 1421. A firmware download/unload instructing section 1426 instructs the firmware download from the server 100 (see FIG. 36) and the unloading of the firmware set in the firmware retaining section 316, under the control of the process management section 1421.

A context data load/unload instructing section 1427 instructs loading and unloading of context data, that is, a value of a register (not shown) in the CPU 1410.

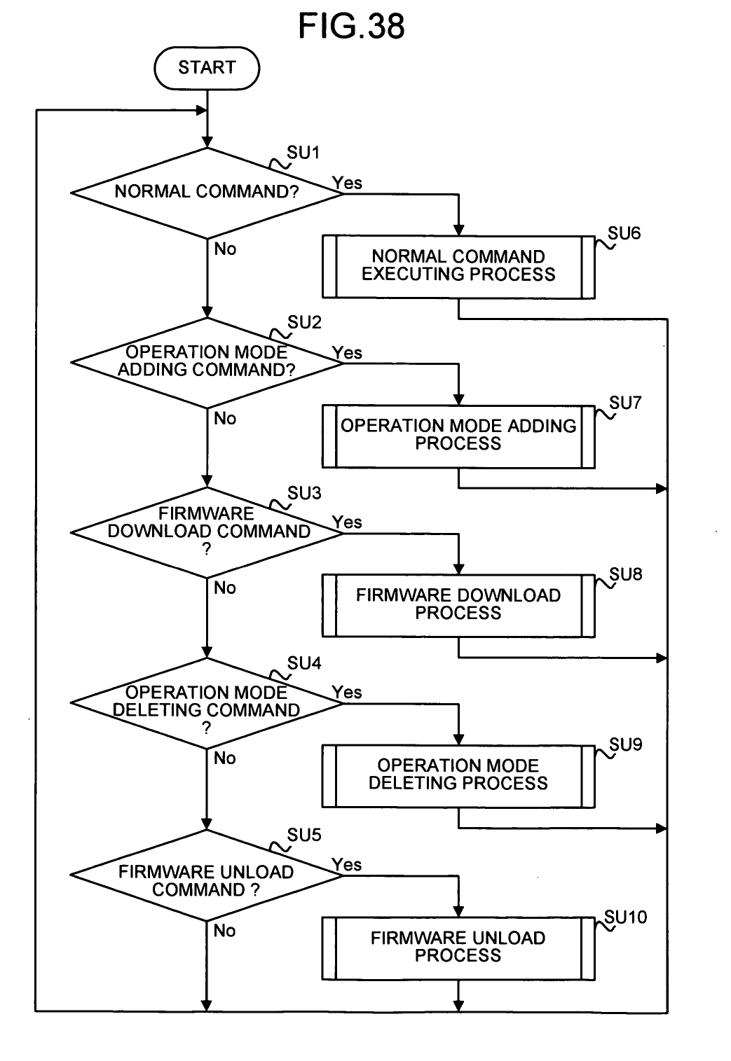

An operation of the CPU 1410 according to the seventh embodiment is explained below with reference to flowcharts shown in FIGS. 38 to 41. The CPU 1410 determines whether a normal command is input (step SU 1 shown in FIG. 38), and in this case, a result is assumed to be “No”.

The CPU 1410 determines whether the operation mode adding command is input (step SU2), and in this case, a result is assumed to be “No”. The CPU 1410 determines whether the firmware download command is input (step SU3), and in this case, a result is assumed to be “No”.

The CPU 1410 determines whether an operation mode deleting command is input (step SU 4), and in this case, a result is assumed to be “No”. The operation mode deleting command deletes the operation mode set in the operation mode retaining section 312 (see. FIG. 37).

The CPU 1410 determines whether the firmware unload command is input (step SU5), and in this case, a result is assumed to be “No”. The firmware unload command unloads the firmware set in the firmware retaining section 316. Thereafter, the CPU 1410 repeats the steps SU1 to SU5.

If the normal command is input, the CPU 1410 sets the result at step SU1 to “Yes”. The CPU 1410 executes the normal command executing process (see FIG. 5) at step SU6 similar to the first embodiment.

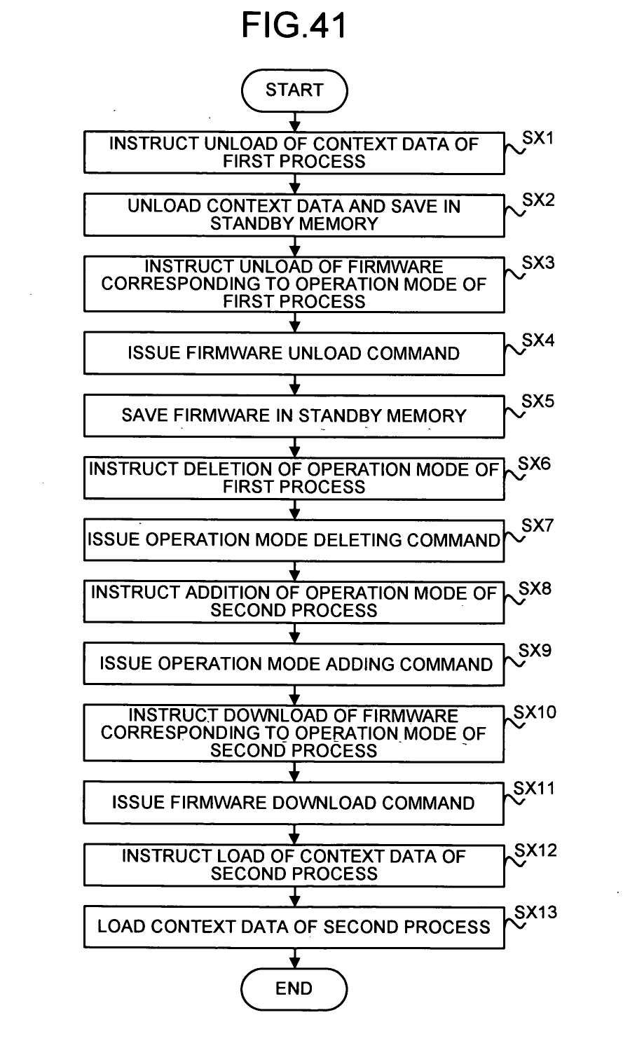

When the operation mode (for example, the operation mode 0) is added and the operation mode (for example, the operation mode 1) is deleted, the process management section 1421 of the operating system 1420 shown in FIG. 37 instructs the context data load/unload instructing section 1427 to unload context data of the first process 1422 at step SX1 shown in FIG. 41.

The context data load/unload instructing section 1427 unloads the context data of the first process 1422 from the CPU 1410, and saves the context data in the standby memory 1424 via the process management section 1421 (step SX2).

The process management section 1421 instructs the firmware download/unload instructing section 1426 to unload firmware corresponding to the operation mode (operation mode 1) of the first process 1422 (step SX3). The firmware download/unload instructing section 1426 issues the firmware unload command to the CPU 1410 (step SX4).

When the firmware unload command is input, the CPU 1410 sets the determined result at step SU5 shown in FIG. 38 to “Yes”. The CPU 1410 executes the firmware unload process at step SU10.

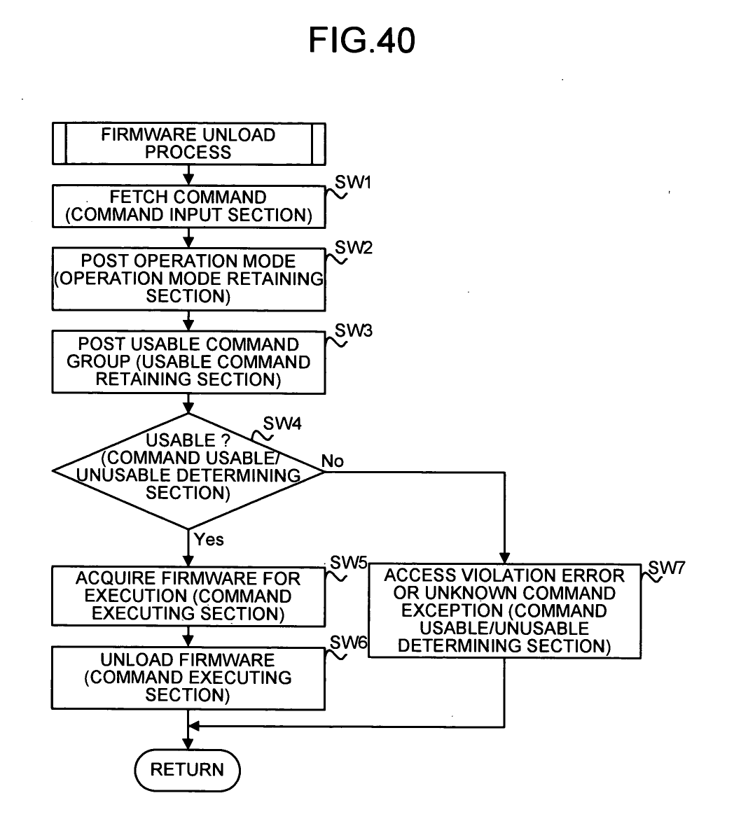

Concretely, at step SW1 in FIG. 40, the command input section 311 (see FIG. 37) fetches the firmware unload command input via the command bus to the command usable/unusable determining section 314 and the command executing section 1411. The operation mode retaining section 312 posts the operation mode 1 set at this time to the usable command retaining section 313 (step SW2).

The usable command retaining section 313 posts the usable command groups corresponding to the operation mode posted, to the command usable/unusable determining section 314 (step SW3).

The command usable/unusable determining section 314 determines whether the firmware unload command fetched at step SW1 is usable in the operation mode (step SW4). If the result is “No”, the command usable/unusable determining section 314 processes this command as access violation error or unknown command exception (step SW7).

In this case, when the result at step SW4 is “Yes”, the command executing section 1411 acquires the firmware for execution corresponding to the firmware unload command (usable command) fetched at step SW1, from the firmware retaining section 316 (step SW5).

Based on the firmware unload command and the corresponding firmware for execution, the command executing section 1411 unloads the firmware corresponding to the firmware unload command from the firmware retaining section 316 (step SW6). The command executing section 1411 outputs the firmware to the firmware download/unload instructing section 1426 via the data input/output section 317.

Referring back to FIG. 41, the firmware download/unload instructing section 1426 saves the unloaded firmware in the standby memory 1424 via the process management section 1421 (step SX5). The process management section 1421 instructs the operation mode addition/deletion instructing section 1425 to delete the operation mode 1 of the first process 1422 (step SX6). The operation mode addition/deletion instructing section 1425 issues the operation mode deleting command for deleting the operation mode 1 to the CPU 1410 (step SX7).

When the operation mode deleting command is input, the CPU 1410 sets the determined result at step SU4 shown in FIG. 38 to “Yes”. The CPU 1410 executes the operation mode deleting process at step SU9.

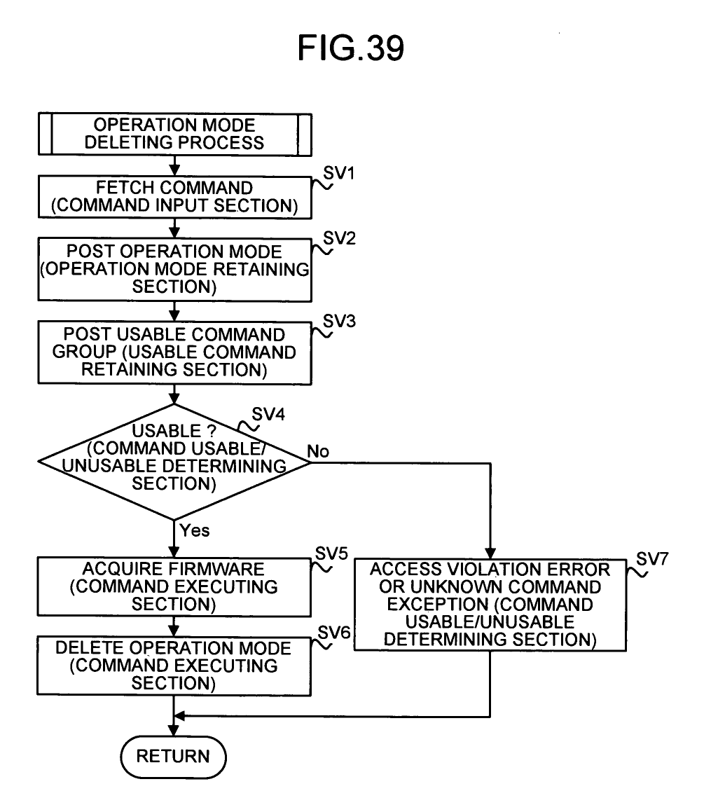

Concretely, at step SV1 shown in FIG. 39, the command input section 311 (see FIG. 37) fetches the operation mode deleting command input via the command bus to the command usable/unusable determining section 314 and the command executing section 1411.

The operation mode retaining section 312 posts the operation mode set at this time to the usable command retaining section 313 (step SV2).

The usable command retaining section 313 posts the usable command group corresponding to the operation mode posted, to the command usable/unusable determining section 314 (step SV3).

The command usable/unusable determining section 314 determines whether the operation mode deleting command fetched at step SV1 is usable in the operation mode (step SV4). If the result is “No”, the command usable/unusable determining section 314 processes the command as access violation error or unknown command exception (step SV7).

In this case, when the result at step SV4 is “Yes”, the command executing section 1411 acquires the firmware corresponding to the operation mode deleting command (usable command) fetched at step SV1, from the firmware retaining section 316 (step SV5).

The command executing section 1411 deletes the operation mode instructed by the operation mode addition/deletion instructing section 1425, from the operation modes set in the operation mode retaining section 312 (step SV6).

Referring back to FIG. 41, the process management section 1421 instructs the operation mode addition/deletion instructing section 1425 to add the operation mode 0 of the second process 1423 (step SX8). The operation mode addition/deletion instructing section 1425 issues the operation mode adding command for adding the operation mode 0 to the CPU 1410 (step SX9).

When the operation mode adding command is input, the CPU 1410 sets the determined result at step SU2 shown in FIG. 38 to “Yes”. The CPU 1410 executes the operation mode adding process (see FIG. 6) at step SU7 similar to the first embodiment. Consequently, the operation mode 0 is added to the operation mode retaining section 312.

With reference to FIG. 41, the process management section 1421 instructs the firmware download/unload instructing section 1426 to download the firmware corresponding to the operation mode (operation mode 0) of the second process 1423 (step SX10). The firmware download/unload instructing section 1426 issues the firmware download command to the CPU 1410 (step SX11).

When the firmware download command is input, the CPU 1410 sets the result at step SU3 shown in FIG. 38 to “Yes”. The CPU 1410 executes the firmware download process (see FIG. 7) at step SU8 similar to the first embodiment. Consequently, the firmware corresponding to the operation mode 0 is set in the firmware retaining section 316.

With reference to FIG. 41, the process management section 1421 of the operating system 1420 shown in FIG. 37 instructs the context data load/unload instructing section 1427 to load the context data of the second process 1423 (step SX12). The context data load/unload instructing section 1427 loads the context data of the second process 1423 to the CPU 1410 (step SX13).

Thus, according to the seventh. embodiment, the dynamically specified operation mode from the plurality of operation modes is deleted from the operation mode retaining section 312. Further, the firmware corresponding to the operation mode deleted is deleted from the firmware retaining section 316. Therefore, the limited resources of the CPU 1410 can be used effectively.

In the first embodiment, when an unknown command exception occurs at step SB9 (see FIG. 5), step SC8 (see FIG. 6) or step SD8 (see FIG. 7), the normal command executing process, the operation mode adding process or the firmware download process are discontinued. However, an emulating section that emulates various processes in the CPU 310 (see FIG. 2) may be provided outside the CPU 310. This case is explained below as an eighth embodiment.

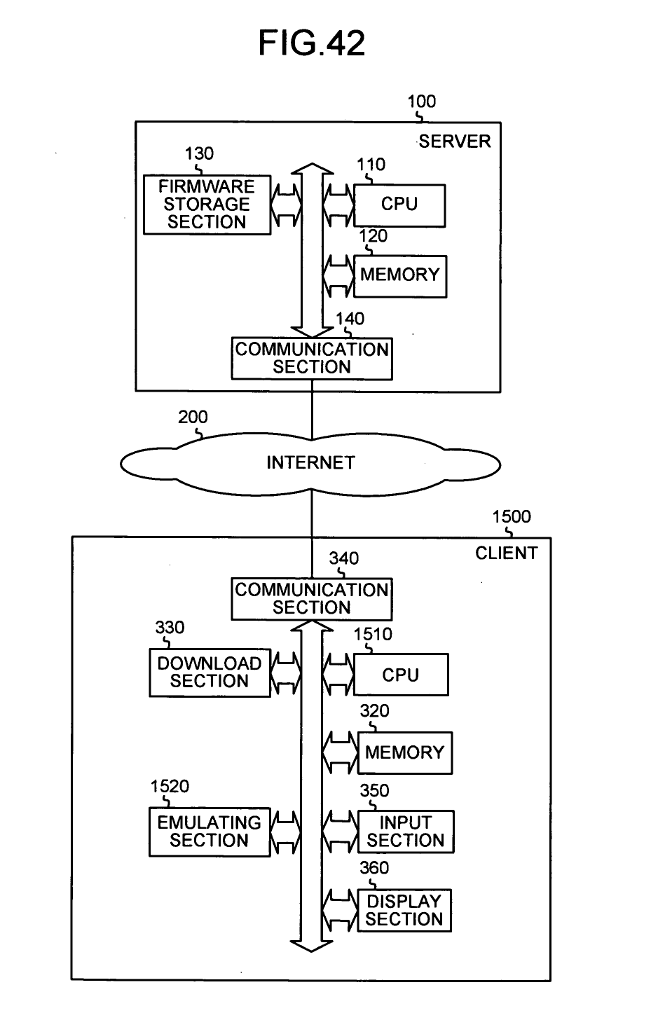

FIG. 42 is a block diagram of a constitution according to the eighth embodiment of the present invention. Portions corresponding to those in FIG. 1 are designated by identical reference numerals, and the explanation thereof is omitted.

A client 1500 is connected to the Internet 200. The client 1500 includes a function for downloading firmware from the server 100 via the Internet 200, a function for executing various commands using the firmware to output results, and an emulating function.

In the client 1500, a CPU 1510 controls the dynamic download of firmware, and sets operation modes and command groups. When an unknown command exception occurs in the CPU 1510, an emulating section 1520 emulates the normal command executing process, the operation mode adding process or the firmware download process.

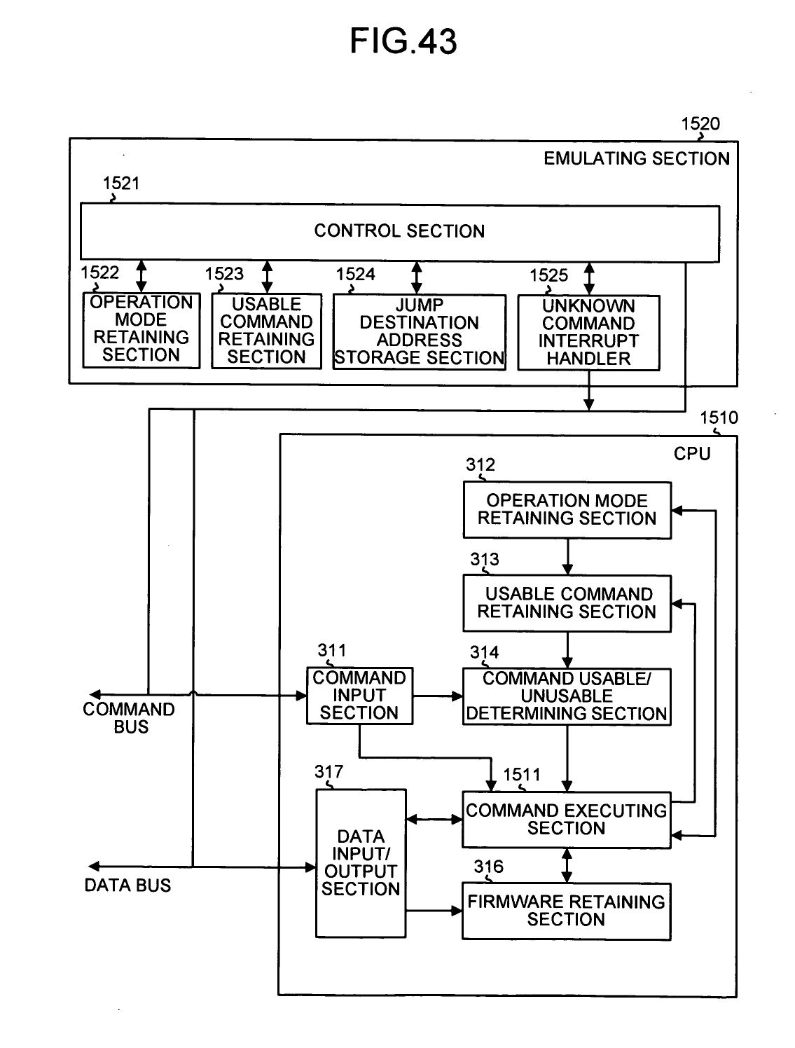

FIG. 43 is a block diagram of the CPU 1510 and the emulating section 1520 shown in FIG. 42. Portions corresponding to those in FIG. 2 are designated by identical reference numerals, and the explanation thereof is omitted.

The command executing section 1511 acquires firmware to be used for executing a command determined as usable by the command usable/unusable determining section 314, from the firmware retaining section 316 to execute the command. Further, when unknown command exception occurs during execution of the command, the command executing section 1511 jumps to an address of the emulating section 1520. The command executing section 1511 makes the emulating section 1520 emulate the process corresponding to the command.

In the emulating section 1520, a control section 1521 controls other sections. An operation mode retaining section 1522, like the operation mode retaining section 312, retains operation modes. A usable command retaining section 1523, like the usable command retaining section 313, retains usable commands corresponding to the operation modes set in the operation mode retaining section 1522.

A jump destination address storage section 1524 stores jump destination addresses in the case of unknown command exception. An unknown command interrupt handler 1525, like the command executing section 1511, emulates a process in the command executing section 1511 when an unknown command exception occurs.

An operation of the eighth embodiment is explained below with reference to flowcharts shown in FIGS. 5 to 7 and 44.

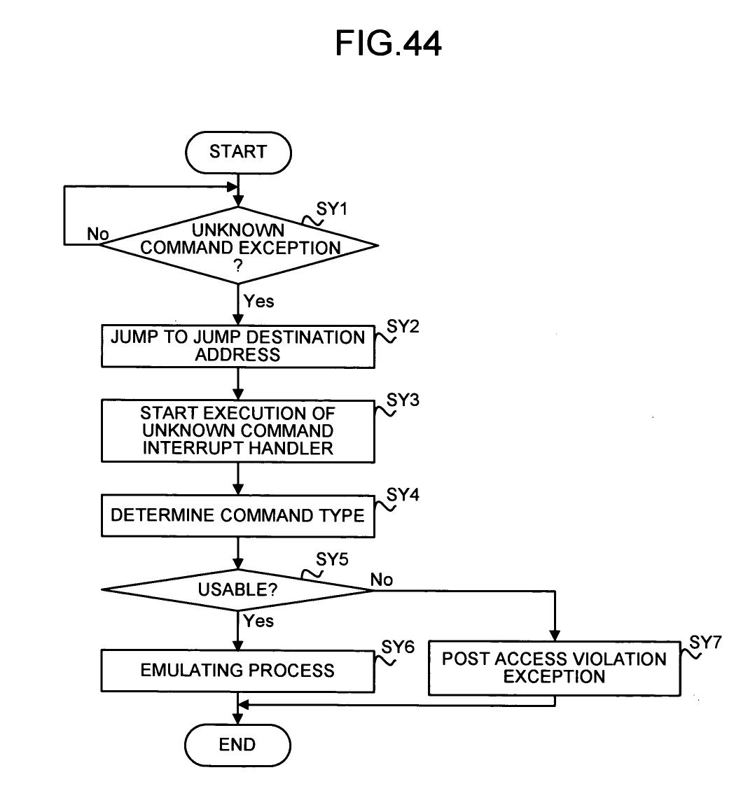

At step SY1 shown in FIG. 44, the command executing section 1511 determines whether an unknown command exception occurred in the normal command executing process, the operation mode adding process or the firmware download process shown in FIG. 5, 6 or 7. In this case, a result is assumed to be “No”, and the determination is repeated.

When an unknown command exception occurs at step SB9 shown in FIG. 5, for example, the command executing section 1511 sets the result at step SY1 to “Yes”. The command executing section 1511 jumps to a jump destination address, and posts the command (in this case, the normal command) and the operation mode to the unknown command interrupt handler 1525 (step SY2). The unknown command interrupt handler 1525 starts execution of the unknown command interrupt handler (step SY3).

The unknown command interrupt handler 1525 determines a type of the command posted by the command executing section 1511 (step SY4). The unknown command interrupt handler 1525 determines whether the command (in this case, the normal command) is usable (step SY5).

Concretely, the unknown command interrupt handler 1525 acquires the usable command group corresponding to the operation mode posted from the usable command retaining section 1523. The unknown command interrupt handler 1525 determines whether the usable command group includes the command (in this case, the normal command), and in this case, a result is assumed to be “Yes”.

The unknown command interrupt handler 1525 emulates the command, which, in this case, is the normal command (step SY6). Concretely, the unknown command interrupt handler 1525 acquires the firmware corresponding to the command (in this case, the normal command) from the firmware retaining section 316.

After the unknown command interrupt handler 1525 acquires data to be used for executing the command from the data bus, it executes the normal command using the firmware and the data. The unknown command interrupt handler 1525 outputs a result of executing the normal command to the data bus.

On the other hand, when the result at step SY5 is “No”, the unknown command interrupt handler 1525 posts access violation exception to the command executing section 1511 (step SY7).

Thus, according to the eighth embodiment, when an unknown command exception occurs in the command corresponding to the operation mode retained in the operation mode retaining section 312, the emulating section 1520 is requested to execute the command. Therefore, command execution is more reliable.

Although the first to the eighth embodiments of the present. invention are explained in detail with reference to the drawings, the concrete constitutional example is not limited to the first to the eighth embodiments. Modifications of the design that are within the gist of the present invention are included in the present invention.

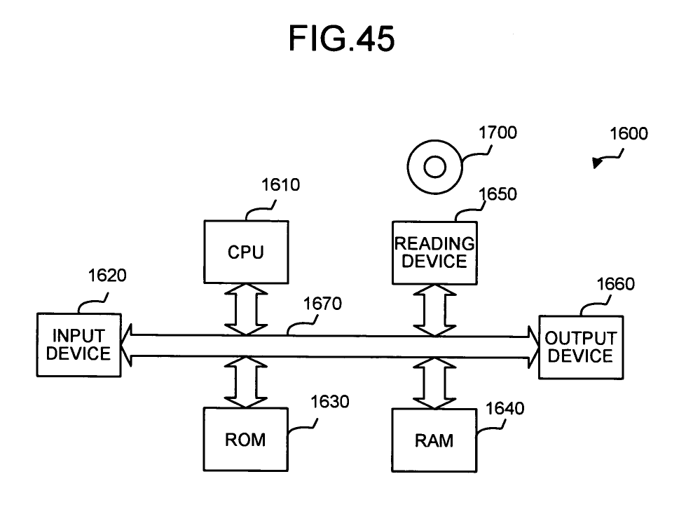

For example, in the first to eighth embodiments, programs for realizing the various functions may be recorded into a recording medium 1700 readable by a computer as shown in FIG. 45. The programs recorded into the recording medium 1700 are read by the computer 1600 in FIG. 45, and are executed to realize the functions.

The computer 1600 is composed of a CPU 1610 for executing the programs, an input device 1620 such as a keyboard and a mouse, a ROM 1630 for storing various data, a RAM 1640 for storing operation parameters or the like, a reading device 1650 for reading the programs from the recording medium 1700, an output device 1660 such as a display or a printer, and a bus 1670 for connecting the respective sections.

The CPU 1610 reads the programs recorded in the recording medium 1700 via the reading device 1650, and executes the programs to realize the functions. The recording medium 1700 includes portable recording media such as an optical disc, a flexible disc and a hard disc, and transmission media such as a network for temporarily recording data therein.

The various characteristics explained in the first to the eighth embodiments may be combined. A constitution of the combination may be included in the present invention.

As explained above, according to the present invention, a dynamically specified operation mode is added into an operation mode retaining unit, and a command corresponding to the operation mode added is set in a usable command retaining unit. Further, firmware to be used for executing the command is acquired from the outside. Therefore, while security of information is maintained, extensibility improves, and cost reduces.

According to the present invention, an encrypted firmware is acquired from the outside and then decrypted. Therefore, the security during the acquiring of the firmware strengthens.

According to the present invention, digitally signed firmware is acquired from the outside and then authenticated. Therefore, it is assured that the firmware acquired is unaltered.

According to the present invention, access to various resources to be used for executing the command is controlled based on the operation modes. Therefore, the resources can be dynamically allocated depending upon the operation modes.

According to the present invention, only if the number of the commands of the dynamically specified operation mode is greater than the number of the commands of the operation modes already retained in the operation mode retaining unit, the dynamically specified operation mode is added into the operation mode retaining unit. Therefore, adding an operation mode under strict conditions further strengthens security.

According to the present invention, a dynamically specified operation mode is deleted from the operation mode retaining unit, and the firmware corresponding to the deleted operation mode is deleted. Therefore, the limited resources in the central processing unit are used effectively.

According to the present invention, if an error occurs during execution of a command corresponding to the operation mode retained in the operation mode retaining unit, an external emulator is requested to execute the command. Therefore, the reliability of the command execution improves.

According to the present invention, a dynamically specified operation mode is added into the operation mode retaining unit, and a command corresponding to the operation mode added is set in the usable command retaining unit. Further, logic circuit data that corresponds to an operation mode retained in the operation mode retaining unit and that is used for generating a logic circuit to be used for executing the command, are acquired from the outside. Therefore, while security of information is maintained, extensibility improves, and cost reduces.

According to the present invention, when a command is executed, the logic circuit is dynamically generated based on the logic circuit data corresponding to the command. Therefore, while security of information is maintained, extensibility improves, and cost reduces.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A central processing unit, comprising:
an operation mode storing unit that stores at least one first operation mode from among a plurality of second operation modes;
a usable command storing unit that stores at least one command corresponding to the at least one first operation mode stored as at least one usable command;
an operation mode adding/setting unit that adds into the operation mode storing unit a dynamically specified operation mode from the second operation modes, and sets in the usable command storing unit the at least one command corresponding to the operation mode added; and
a firmware acquiring unit that acquires from outside, firmware that corresponds to the at least one first operation mode stored and that is used for executing the at least one usable command.

2. The central processing unit according to claim 1, wherein the firmware acquiring unit acquires encrypted firmware from the outside, and decrypts the encrypted firmware.

3. The central processing unit according to claim 1, wherein the firmware acquiring unit acquires digitally signed firmware from the outside, and authenticates the firmware.

4. The central processing unit according to claim 1, further comprising an access control unit that controls access to resources, which are required during execution of the at least one usable command corresponding to the at least one first operation mode.

5. The central processing unit according to claim 1, wherein if number of the at least one usable command corresponding to the dynamically specified operation mode is greater than number of the at least one usable command corresponding to the at least one first operation mode stored, the operation mode adding/setting unit adds into the operation mode storing unit the dynamically specified operation mode, and sets in the usable command storing unit the at least one command corresponding to the operation mode added.

6. The central processing unit according to claim 1, further comprising:
an operation mode deleting unit that deletes from the operation mode storing unit a dynamically specified operation mode from the at least one first operation mode stored; and
a firmware deleting unit that deletes firmware corresponding to the operation mode deleted.

7. The central processing unit according to claim 1, further comprising an execution request unit that requests an external emulator to execute the at least one usable command corresponding to the at least one first operation mode stored, if an error occurs during execution of the at least one usable command.

8. A central processing unit, comprising:
an operation mode storing unit that stores at least one first operation mode from among a plurality of second operation modes;
a usable command storing unit that stores at least one command corresponding to the at least one first operation mode stored as at least one usable command;
an operation mode adding/setting unit that adds into the operation mode storing unit a dynamically specified operation mode from the second operation modes, and sets in the usable command storing unit a command corresponding to the operation mode added; and
a logic circuit data acquiring unit that acquires logic circuit data from the outside for generating a logic circuit that corresponds to the at least one first operation mode stored and that is used for executing the at least one usable command.

9. The central processing unit according to claim 8, further comprising a logic circuit generating unit that dynamically generates a logic circuit based on the logic circuit data corresponding to the at least one usable command, when the at least one usable command is executed.

10. A computer program that makes a computer execute:
storing at least one first operation mode from among a plurality of second operation modes;
storing at least one command corresponding to the at least one first operation mode stored as at least one usable command;
adding a dynamically specified operation mode from the second operation modes, and setting a command corresponding to the operation mode added; and
acquiring from outside, firmware that corresponds to the at least one first operation mode stored and that is used for executing the at least one usable command.

11. The computer program according to claim 10, wherein the acquiring includes acquiring encrypted firmware from the outside, and decrypting the encrypted firmware.

12. The computer program according to claim 10, wherein the acquiring includes acquiring digitally signed firmware from the outside, and authenticating the firmware.

13. The computer program according to claim 10, further making the computer execute controlling access to resources, which are required during execution of the at least one usable command corresponding to the at least one first operation mode.

14. The computer program according to claim 10, wherein if number of the at least one usable command corresponding to the dynamically specified operation mode is greater than number of the at least one usable command corresponding to the at least one first operation mode stored, the operation mode adding/setting unit adds into the operation mode storing unit the dynamically specified operation mode, and sets in the usable command storing unit the at least one command corresponding to the operation mode added.

15. The computer program according to claim 10, further making the computer execute:
deleting from the operation mode storing unit a dynamically specified operation mode from the at least one first operation mode stored; and
deleting firmware corresponding to the operation mode deleted.

16. The computer program according to claim 10, further making the computer execute making a request to an external emulator to execute the at least one usable command corresponding to the at least one first operation mode stored, if an error occurs during execution of the at least one usable command.
